(19) United States
(12) Patent Application Publication
(10) Pub. No.: US 2013/0201520 A1
(43) Pub. Date: Aug. 8, 2013

(54) INFORMATION PROCESSING APPARATUS, INFORMATION PROCESSING METHOD, AND COMPUTER-READABLE MEDIUM

(71) Applicant: CANON KABUSHIKI KAISHA, Tokyo (JP)

(72) Inventor: Junko Sato, Yokohama-shi (JP)

(73) Assignee: CANON KABUSHIKI KAISHA, Tokyo (JP)

(21) Appl. No.: 13/682,382

(22) Filed: Nov. 20, 2012

(30) Foreign Application Priority Data
Feb. 7, 2012 (JP) 2012-024524

(51) Int. Cl. G06K 15/02

(52) U.S. Cl. CPC G06K 15/02
USPC 358/1.15

(57) ABSTRACT

An information processing apparatus which prints a printed product including a plurality of pages, the apparatus comprises: a display control unit which displays, when the setting for designating the paper sheet by a feed unit is made and a type of paper fed from the feed unit designated by the user is a predetermined type of paper, a screen for setting detail information of the predetermined type of paper, and displays, when the setting for designating the paper sheet by a paper type is made and a type of paper designated by the user is a predetermined type of paper, a screen for setting a feed unit which feeds the designated predetermined type of paper and detail information of the designated predetermined type of paper.

### BACKGROUND OF THE INVENTION

1. Field of the Invention

The present invention relates to an information processing apparatus, an information processing method, and a computer-readable medium.

2. Description of the Related Art

A program called an office suite, which includes various types of applications forming one integrated application, provides a function of constructing one document by combining the data generated by the respective applications. Using this integrated application allows the user to compile the data generated by the respective applications into one document using a specific application included in the integrated application.

Some integrated applications have a function of inserting paper sheets having special meanings for a print job (see Japanese Patent Laid-Open No. 2003-91390). Such an integrated application includes patterns defining in advance combinations/orders of insertion sheets prepared as options. By selecting a desired pattern from these options, the user can insert inserting paper as delimiter paper for each group of several pages (to be referred to as a section hereinafter) and insert index paper for each section.

Some integrated applications have a function of changing print attributes such as an output sheet to be used for printing and color and monochrome modes on a page setting screen (Japanese Patent Laid-Open No. 2011-146032). When, for example, changing output sheets for each page by using an integrated application, it is possible to choose between designating an output sheet to be changed with “feed unit” or designating it with “paper type”. When the user has selected “feed unit”, it is possible to change an output sheet by designating the feed unit (a cassette or each paper feed tray of an inserter) of the printer which is to be used for printing for each page. When the user has selected “paper type” as a paper feed method, it is possible to set an output sheet to be used for printing for each page with the name of paper type. For example, when the user sets “index paper” as a paper type, the integrated application handles the corresponding page as index paper, and the user can print only desired pages on the index paper.

As described above, when the user wants to change an output sheet for each page in the prior art, he/she can print a specific page as index paper by designating, for example, “index paper” as “paper type” on a page setting screen. The prior art gives no consideration to a method of designating a predetermined output sheet (for example, index paper) in a case in which the user has selected “feed unit” when designating an output sheet.

For this reason, although there are available a method of designating “paper type” and a method of designating “feed unit” as methods of designating index paper, a problem arises in that screens suitable for the respective methods are not displayed. As a result, there have been problems that, for example, printing is performed up to the tab portions (index tabs) of index paper, and a printer does not perform residue tab sheet discharge (the processing of automatically discharging excess index paper in accordance with the number of tabs on the printer side).

### SUMMARY OF THE INVENTION

According to one aspect of the present invention, there is provided an information processing apparatus which prints a printed product including a plurality of pages, the apparatus comprising: an accepting unit configured to accept one of a setting for designating, by a feed unit, a paper sheet to be inserted at a desired position of the plurality of pages, and a setting of designating, from a type of paper, a paper sheet to be inserted at a desired position of the plurality of pages; and a display control unit configured to display, when the setting for designating the paper sheet by a feed unit is made and a type of paper fed from the feed unit designated by the user is a predetermined type of paper, a screen for setting detail information of the predetermined type of paper, and to display, when the setting for designating the paper sheet by a paper type is made and a type of paper designated by the user is a predetermined type of paper, a screen for setting a feed unit which feeds the designated predetermined type of paper and detail information of the designated predetermined type of paper.

According to another aspect of the present invention, there is provided an information processing method in an information processing apparatus which prints a printed product including a plurality of pages, the method comprising: accepting one of a setting for designating, by a feed unit, a paper sheet to be inserted at a desired position of the plurality of pages, and a setting of designating, from a type of paper, a paper sheet to be inserted at a desired position of the plurality of pages; displaying, when the setting for designating the paper sheet by a feed unit is made and a type of paper fed from the feed unit designated by the user is a predetermined type of paper, a screen for setting detail information of the predetermined type of paper, and displaying, when the setting for designating the paper sheet by a paper type is made and a type of paper fed designated by the user is a predetermined type of paper, a screen for setting a feed unit which feeds the designated predetermined type of paper and detail information of the designated predetermined type of paper.

According to another aspect of the present invention, there is provided a non-transitory computer-readable medium storing a program for causing a computer to function as an accepting unit configured to accept one of a setting for designating, by a feed unit, a paper sheet to be inserted at a desired position of a plurality of pages constituting printed product, and a setting of designating, from a type of paper, a paper sheet to be inserted at a desired position of the plurality of pages; and a display control unit configured to display, when the setting for designating the paper sheet by a feed unit is made and a type of paper fed from the feed unit designated by the user is a predetermined type of paper, a screen for setting detail information of the predetermined type of paper, and to display, when the setting for designating the paper sheet by a paper type is made and a type of paper designated by the user is a predetermined type of paper, a screen for setting a feed unit which feeds the designated predetermined type of paper and detail information of the designated predetermined type of paper.

When outputting a document file by using a plurality of types of paper sheets, this technique facilitates making settings for the respective pages constituting the document file.

Further features of the present invention will become apparent from the following description of exemplary embodiments (with reference to the attached drawings).

### BRIEF DESCRIPTION OF THE DRAWINGS

FIG. 1 is a block diagram for explaining the arrangement of a standalone type document processing system;

FIG. 2 is a block diagram showing an example of the arrangement of the host computer of a document processing system;

FIGS. 3A and 3B are views showing an example of the structure of a book file;

FIGS. 4A and 4B are views for explaining an example of book attributes;

FIG. 5 is a view for explaining an example of section attributes;

FIG. 6 is a view for explaining an example of page attributes;

FIG. 7 is a flowchart for the processing of opening a book file;

FIG. 8 is a flowchart for the processing of importing an electric document file in a book file;

FIG. 9 is a flowchart for the processing of converting application data into an electric document file;

FIG. 10 is a view showing an example of an UI screen when a generated book file is opened;

FIG. 11 is a view showing an example of an UI screen when a new book file is opened;

FIG. 12 is a block diagram showing an example of the arrangement of a client-server type document processing system;

FIG. 13 is a block diagram showing an example of the arrangements of a host computer and printer of the document processing system;

FIG. 14 is a view showing an example of a setting screen for insertion sheets according to the present invention;

FIG. 15 is a flowchart for the processing of reflecting insertion sheet attributes in the attributes of a book file;

FIGS. 16A, 16B, and 16C are views each showing an example of a page setting screen;

FIGS. 17A and 17B are views each showing an example of a page setting screen;

FIG. 18 is a flowchart for display processing for a page setting screen;

FIG. 19 is a view showing an example of an index paper information table;

FIG. 20 is a flowchart for the processing of deciding initial setting contents on a page setting screen;

FIG. 21 is a flowchart for index paper information table update processing;

FIG. 22 is a view showing an example of the warning message issued by a bookbinding application;

FIG. 23 is a flowchart for the processing of preventing overlap setting on index paper and a text by the bookbinding application; and

FIG. 24 is a view showing an example of preview display which discriminates a plurality of types of index paper.

### DESCRIPTION OF THE EMBODIMENTS

An embodiment of the present invention will be described below with reference to the accompanying drawings.

<Outline of System>

An outline of a document processing system according to an embodiment to which the present invention can be applied will be explained with reference to the accompanying drawings. This document processing system converts the data file generated by a general application into an electric document file using an electric document writer. A bookbinding application provides a function of editing the electric document file. This function will be described in detail below.

<System Configuration and Operation>

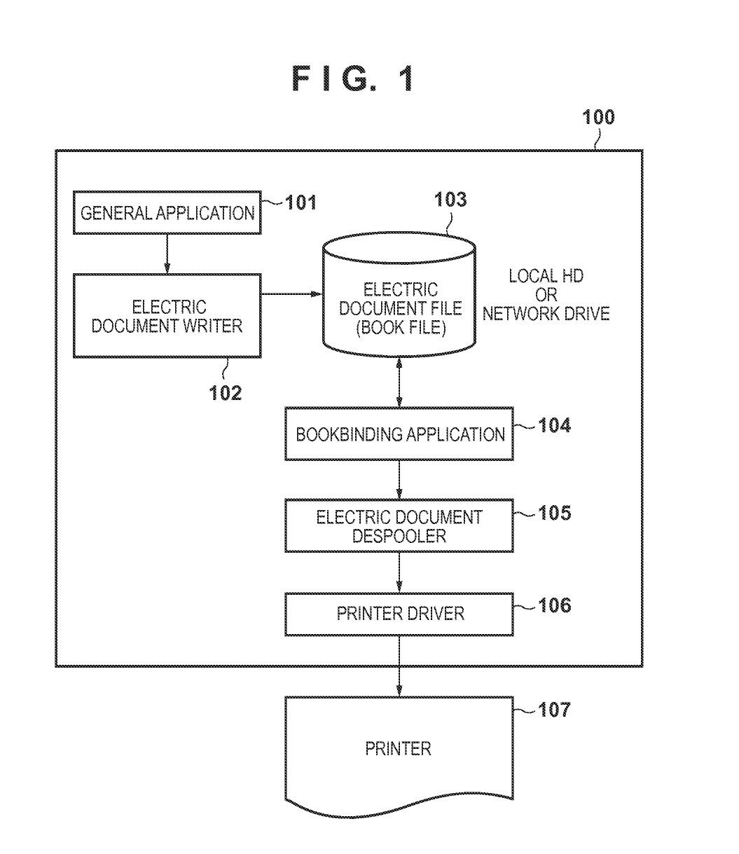

FIG. 1 is a block diagram showing an example of the software arrangement of the document processing system according to the embodiment of the present invention. This document processing system is implemented by a host computer 100 which is an information processing apparatus according to the embodiment. A general application 101 is an application program which provides a wordprocessing function, spreadsheet function, photo retouch function, draw or paint function, presentation function, text editing function, and the like. This application has a printing function.

The application programs use a predetermined interface provided by an operating system (OS) when printing application data such as generated document data or image data. That is, in order to print generated data, the general application 101 transmits an output command (GDI function) in a predetermined format dependent on the OS to an output module of the OS which provides an interface. Upon receiving this output command, the output module converts the command into a format which can be processed by an output device such as a printer, and outputs the converted command (DDI function).

Since the format which can be processed by this output device differs depending on the type, maker, and model of output device, a device driver is provided for each output device. The OS generates print data by converting the command by using the corresponding device driver, and compiles the data by using JL (Job Language), thereby generating a print job. If Windows® available from Microsoft is used as an OS, a module called GDI (Graphic Device Interface) corresponds to the above output module.

An electric document writer 102 is an improvement of the above device driver, and is a software module provided to implement this document processing system. However, the electric document writer 102 does not aim at output for a specific output device. The electric document writer 102 generates an electric document file 103 by converting an output command into a format which can be processed by a bookbinding application 104 and a printer driver 106 (both of which will be described later). The format (to be referred to as an “electric document format” hereinafter) after conversion by the electric document writer 102 is not specifically limited as long as it can express a document in a detailed form for each page. As a standard electric document format, it is possible to use, for example, PDF (Portable Document Format) available from Adobe Systems or SGML (Standard Generalized Markup Language).

When the general application 101 uses the electric document writer 102, the electric document writer 102 is designated as a device driver used for output, and then caused to execute printing. The electric document file generated by the electric document writer 102 does not have a complete electric document file format. For this reason, the bookbinding application 104 designates the electric document writer 102 as a device driver, and the electric document writer 102 executes conversion of application data into an electric document file under the control of the bookbinding application 104. The bookbinding application 104 completes a new incomplete electric document file generated by the electric document writer 102 as an electric document file having the following format.

When it is necessary to clearly identify the state of each electric document file, each file is written as follows. The file generated by the electric document writer 102 will be referred to as an “electric document file”. The electric document file given a structure by the bookbinding application 104 will be referred to as a “book file”. If it is not necessary to specifically discriminate such files, a document file generated by an application, an electric document file, and a book file are all referred to as “document files (or document data)”.

As described above, designating the electric document writer 102 as a device driver and making the general application 101 print the data will convert the application data into an electric document format for each page defined by the general application 101. A storage medium such as a hard disk then stores the application data as the electric document file 103. Note that the hard disk may be the local drive of the computer which implements the document processing system according to this embodiment. Alternatively, when the system is connected to a network, the hard disk may be a drive provided on the network. Each page constituting application data will be referred to as a “logical page” or “document page” hereinafter.

The bookbinding application 104 provides the user with a function of reading and editing the “electric document file” or “book file” 103. The bookbinding application 104 provides no function of editing the contents of each page, but provides a function of editing the structure of a section or book (to be described later) constituted by pages each as the minimum unit.

When printing the book file edited by the bookbinding application 104, the bookbinding application 104 activates an electric document despooler 105. The electric document despooler 105 reads out a designated book file from the hard disk. To print each page in the format described in the book file, the electric document despooler 105 generates an output command complying with the output module (not shown) of the OS described above, and outputs the command to the output module (not shown). At this time, the printer driver 106 for a printer 107 used as an output device is designated as a device driver. The output module (not shown) converts the received output command into a device command which can be interpreted by the printer 107 by using the printer driver 106 of the designated printer 107. This device command is transmitted to the printer 107. The printer 107 then prints an image corresponding to the command.

(Hardware Arrangement)

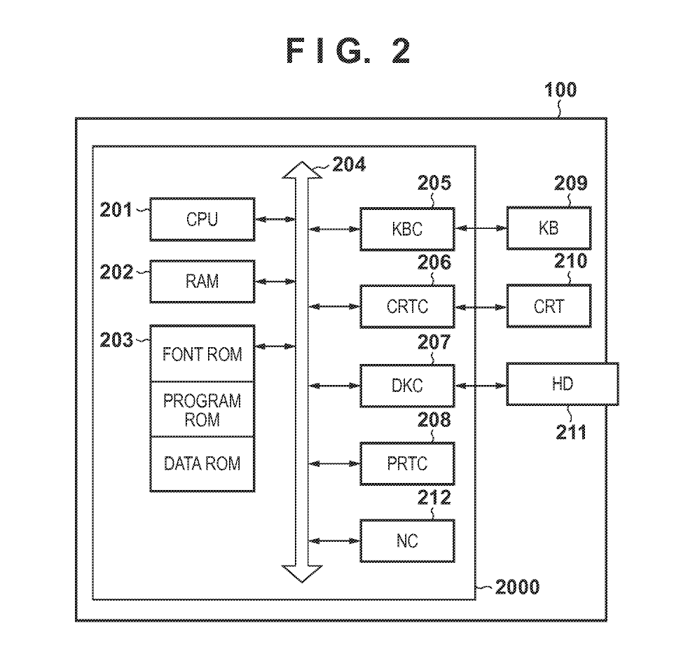

FIG. 2 is a block diagram showing the hardware arrangement of the host computer 100 which is the information processing apparatus shown in FIG. 1. Referring to FIG. 2, a CPU 201 executes programs including the OS, general application 101, and bookbinding application 104 stored in the program ROM of a ROM 203 or loaded from a hard disk 211 to a RAM 202, thereby implementing the software structure in FIG. 1 or flowchart procedures (to be described later) in this embodiment. The RAM 202 functions as the main memory, work area, or the like of the CPU 201.

A keyboard controller (KBC) 205 controls key input operation from a keyboard 209 or a pointing device (not shown). A CRT controller (CRTC) 206 controls display on a CRT 210. Note that the display unit is not limited to a CRT and may be, for example, a liquid crystal display or plasma display. A disk controller (DKC) 207 controls access to the hard disk (HD) 211 or Floppy® disk (FD) (not shown) which stores a boot program, various applications, editing files (to be described later), and the like. A PRTC 208 controls signal exchange with the connected printer 107. An NC 212 is connected to a network, and executes communication control processing with other devices connected to the network.

Note that the hardware arrangement of the information processing apparatus shown in FIG. 2 is an example, and the present invention is not limited to this. That is, this arrangement may include other units.

<Electric Document Data Format>

The data format of the “book file” generated by the bookbinding application 104 described above will be described before the detailed description of the bookbinding application 104.

(Data Structure)

This book file has a three-layered structure similar so a paper-medium book. The upper layer is called a “book”, imitates one book, and defines the attributes of the entire book. The intermediate layer corresponds to a section in the book, and is also called a “section”. As for each “section”, its attributes can be individually defined. The lower layer is a “page”, and corresponds to each page defined by an application program. As for each “page”, its attributes can be individually defined. One “book” may include one or a plurality of “sections”, and one “section” can include one or a plurality of “pages”.

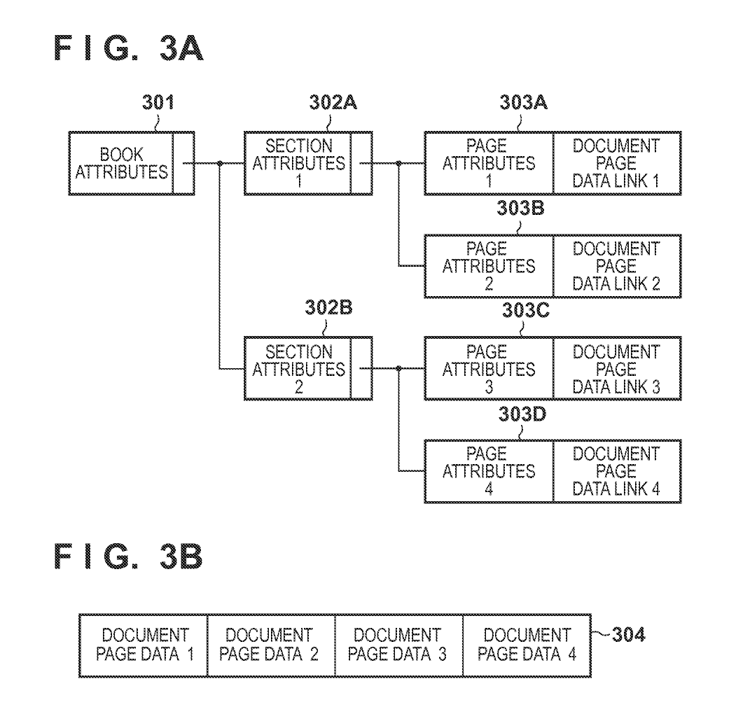

FIG. 3A is a block diagram schematically showing an example of the book file format. This example represents a “book”, “section”, and “page” in the book file using corresponding nodes. One book file includes one “book”. The “book” and “section” are a concept for defining the structure of the “book”, and contain, as entities, defined attribute values and links to lower layers. The “page” has, as an entity, data of each “page” output from an application program. In addition to an attribute value, the “page” contains the entity of a document page (document page data) and a link to each document page data. Note that a print page to be output onto a paper medium or the like includes a plurality of document pages. This structure is displayed not by a link but by an attribute on each of the layers of “book”, “section”, or “page”.

Referring to FIG. 3A, a book 301 defines book attributes, and is linked to two sections 302A and 302B. These links indicate that the sections 302A and 302B are included in the book 301. The section 302A is linked to pages 303A and 303B, which indicates that the section 302A includes these pages. The pages 303A and 303B define attribute values, and contain links to document page data 1 and 2 serving as entities. These links represent data 1 and 2 of document page data 304, as shown in FIG. 3B, and display that the entities of the pages 303A and 303B are document page data 1 and 2.

Likewise, the section 302B includes pages 303C and 303D and links to document page data 3 and 4 which are entities of the pages. These links indicate document page data 3 and 4 of the document page data 304 shown in FIG. 3B, and display that the entities of the pages 303C and 303D are the document page data 3 and 4.

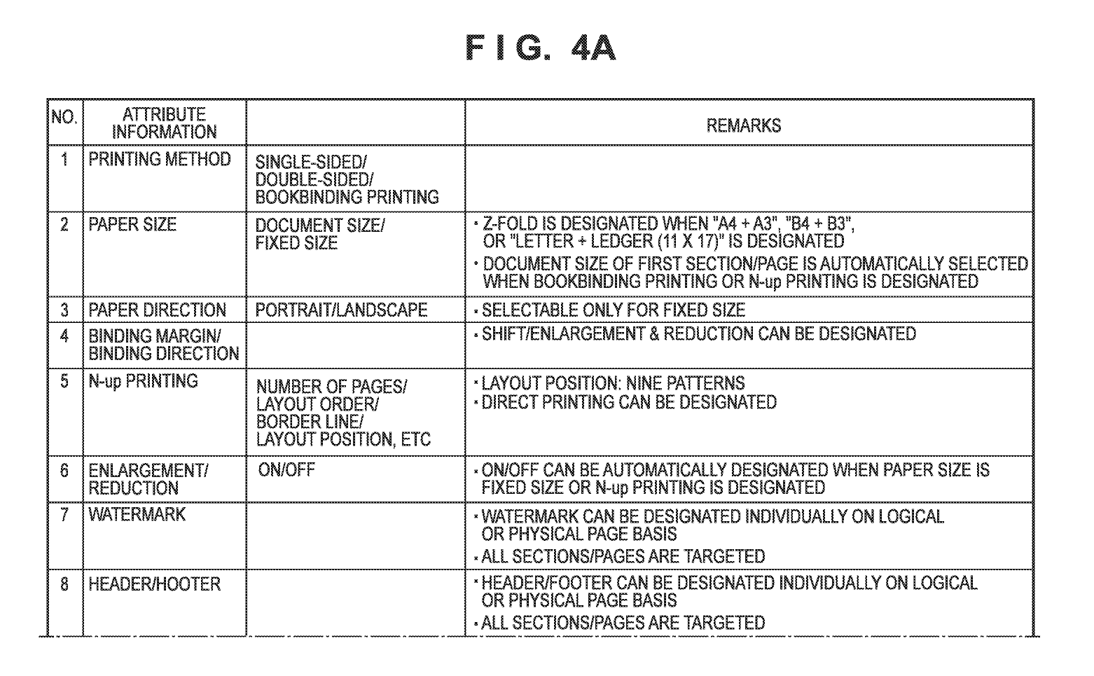

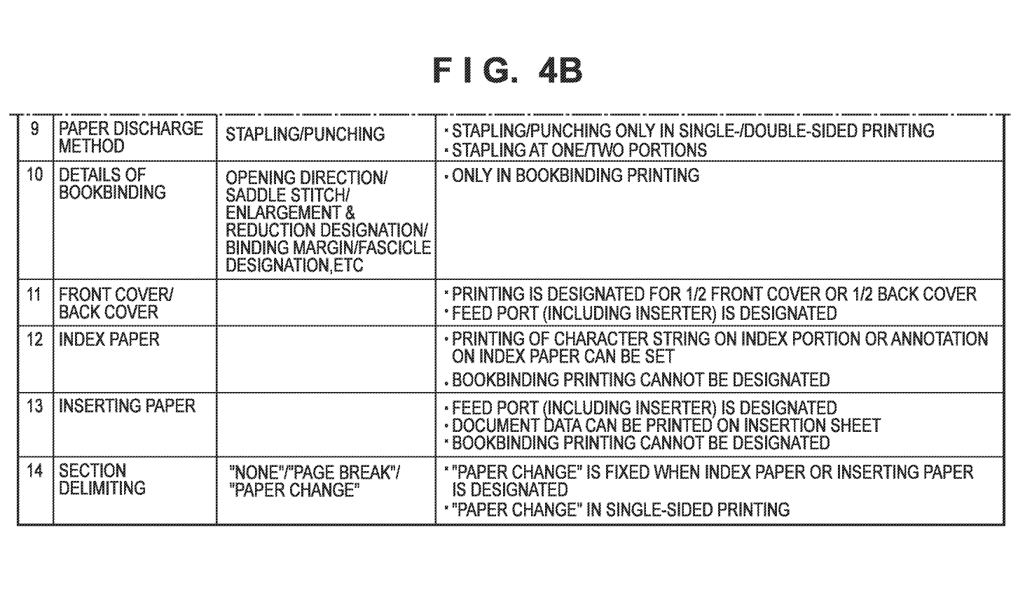

FIGS. 4A and 4B are views for explaining the attributes of the book 301 according to this embodiment. As for an item which can be redundantly defined on a lower layer, the attribute value of the lower layer is preferentially adopted. As for an item contained in only the book 301, a value defined in the book 301 is effective throughout the book. An item redundantly defined on a lower layer is a default value used when this item is not defined on the lower layer. Each item shown in FIGS. 4A and 4B does not always correspond to one concrete item, but may contain a plurality of relevant items.

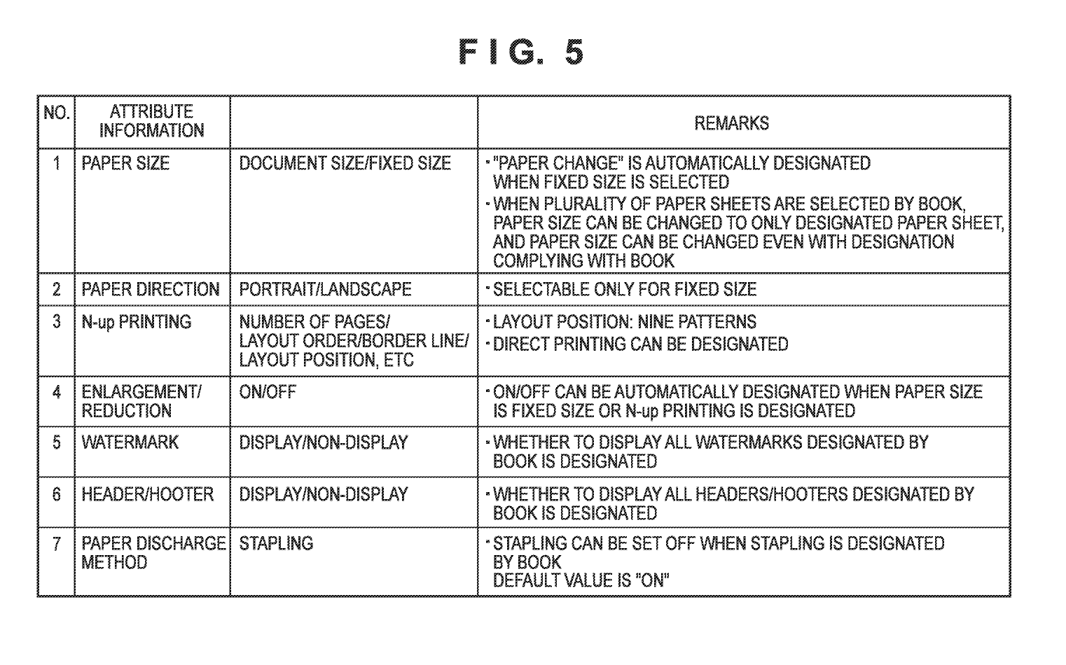

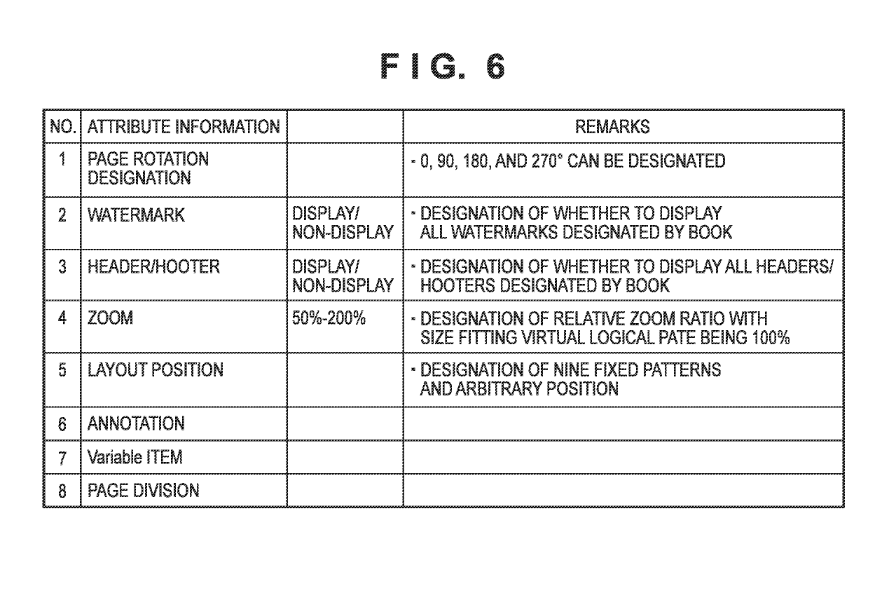

FIG. 5 is a view for explaining section attributes according to this embodiment. FIG. 6 is a view for explaining page at tributes. The relationship between section attributes and page attributes is the same as that between book attributes and lower layer attributes.

Note that the attributes shown in FIGS. 4A to 6 are an example, and the present invention is not limited to them. These attributes can be changed in accordance with the function of the document processing system.

(Book Attributes)

Refer ring to FIGS. 4A and 4B, items unique to the book 301 are six items: “printing method”, “details of bookbinding”, “front cover/back cover”, “index paper”, “inserting paper”, and “section delimiting”. These items are defined throughout the book.

As the attributes of “printing method”, it is possible to designate three values: “single-sided printing”, “double-sided printing”, and “bookbinding printing”. In this case, “bookbinding printing” is a method of printing data in a format which allows bookbinding by bundling a separately designated number of paper sheets, folding the bundle into two, and binding the bundle. As the attributes of “details of bookbinding”, it is possible to designate “opening direction” and “the number of paper sheets to be bundled” when “bookbinding printing” is designated in “printing method”.

The attributes of “front cover/back cover” include the designation of adding paper sheets serving as front and back covers when an electric document file complied as a book is printed, and the designation of contents to be printed on the added paper sheets. The attributes of “index paper” include the designation of inserting index paper with an index tab separately prepared in a printing apparatus for section delimiting, and the designation of contents to be printed on the index tab portion. These attributes become effective when the printing apparatus to be used is equipped with an inserter (not shown) having an inserting function of inserting a paper sheet prepared separately from print paper sheets at a desired position, or when a plurality of paper feed cassettes can be used. This also applies to the attributes to “inserting paper”. The attributes of “inserting paper” include the designation of inserting a paper sheet fed from an inserter (not shown) or a paper feed cassette for section delimiting, and the designation of a paper feed source when inserting paper is inserted.

The attributes of “section delimiting” include the designation of whether to use a new paper sheet, use a new print page, or do nothing particular at a section break. In “single-sided printing”, the use of a new paper sheet is equivalent to the use of a new print page. In “double-sided printing”, designating “the use of a new paper sheet” will inhibit consecutive sections from being printed on one paper sheet, whereas designating “the use of a new print page” allows consecutive sections to be printed on the obverse and reverse surfaces of one paper sheet.

(Section Attributes)

As for the section attributes shown in FIG. 5, there is no item unique to the section, and all items overlapping those of the book attributes. If the definition of a given section attribute is different from that of a corresponding book attribute, the value defined by the section attribute takes precedence over the other. Items common to only the book and section attributes described above are five items: “paper size”, “paper direction”, “N-up printing designation”, “enlargement/reduction”, and “paper discharge method” The attribute of “N-up printing designation” is an item for designating the number of document pages included in one print page. Layouts which can be designated include 1×1, 1×2, 2×2, 3×3, and 4×4. The attribute of “paper discharge method” is an item for designating whether to staple discharged paper sheets. The effectiveness of this attribute depends on whether the printing apparatus has a staple function.

(Page Attributes)

As for the page attributes shown in FIG. 6, items unique to the page attributes include “page rotation designation”, “zoom”, “layout designation”, “annotation”, and “page division”. “Page rotation designation” is an item for designating the rotational angle when a document page is laid out on a print page. The attribute of “zoom” is an item for designating the zoom ratio of a document page. The zoom ratio is designated with a virtual logical page region size=100%. “Virtual logical page region” is a region occupied by one document page when document pages are laid out in accordance with N-up designation or the like. For example, the virtual logical page region is a region corresponding to one print page with the designation of 1×1, and the region obtained by reducing each side of one print page to about 70% with the designation of 1×2.

Attributes common to “book”, “section”, and “page” are a “watermark” attribute and “header/footer” attribute. “Watermark” is a separately designated image or character string printed on the data generated by an application. “Header and footer” are watermarks printed on the upper and lower margins of each page. or the “header and footer”, items such as a page number, and date and time which can be designated by variables are prepared.

The contents which can be designated by the at tributes of “watermark” and “header/footer” are common to “section” and “page”, but are different from those in “book”. “Book” allows to set the contents of “watermark” and “header/footer”, and designate how to print “watermark” or “header/footer” throughout the book. In contrast, “section” and “page” allow to designate whether to print the “watermark” or “header/footer” set by the book on the section or page.

<Book File Generation Procedure>

The “book file” which is the electric document file given a structure by the bookbinding application 104 has the above structure and contents. A procedure of generating a book file by the bookbinding application 104 and the electric document writer 102 will be described next. This book file generation is implemented as part of book file editing operation by the bookbinding application 104.

(Book File Open)

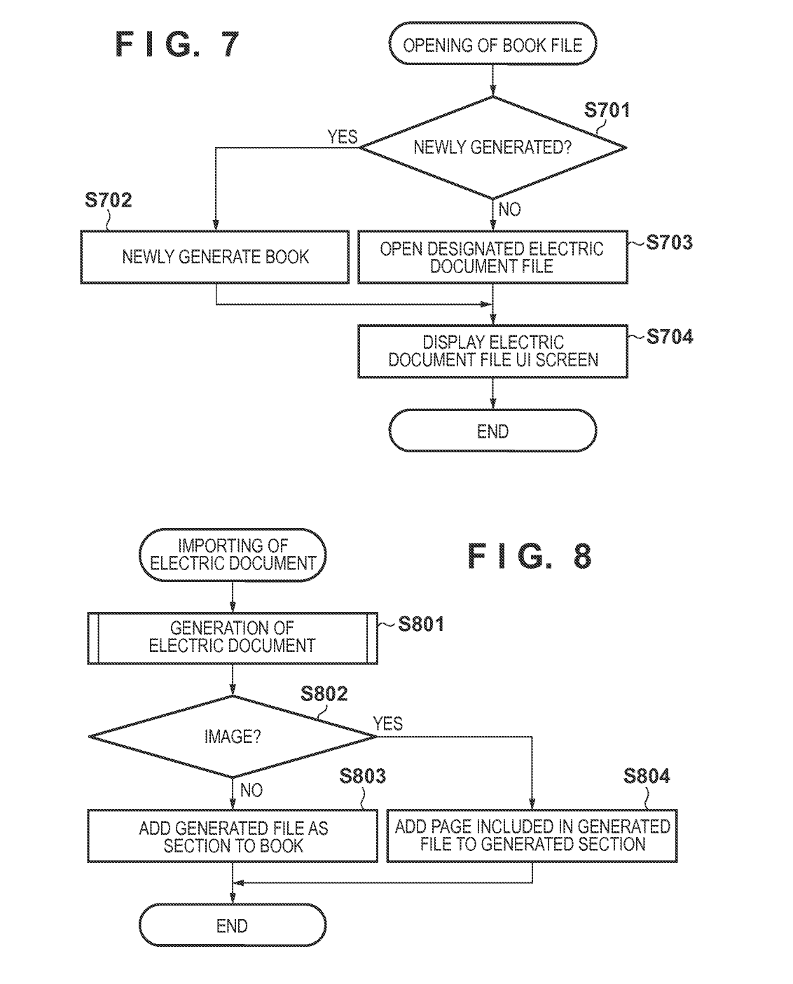

FIG. 7 is a flowchart for explaining a procedure when the bookbinding application 104 according to this embodiment opens a book file. Note that this processing is implemented by making the CPU of the host computer 100, on which the bookbinding application 104 operates, read out programs from an HDD or the like as a storage unit.

First of all, in step S701, the bookbinding application 104 determines whether the book file to be opened is one to be newly generated or an existing one. If the file is one to be newly generated (YES in step S701), The bookbinding application 104 newly generates a book file including no section or page information (step 702). In the example shown in FIGS. 3A and 3B, the newly generated book file is a book node which has only the node of the book 301 without any link to a section node. As the book attributes in this case, a set of attributes prepared in advance for generation of a new book file are applied. The process then advances to step S704, in which the bookbinding application 104 displays a UI (User Interface) screen for editing the new book file.

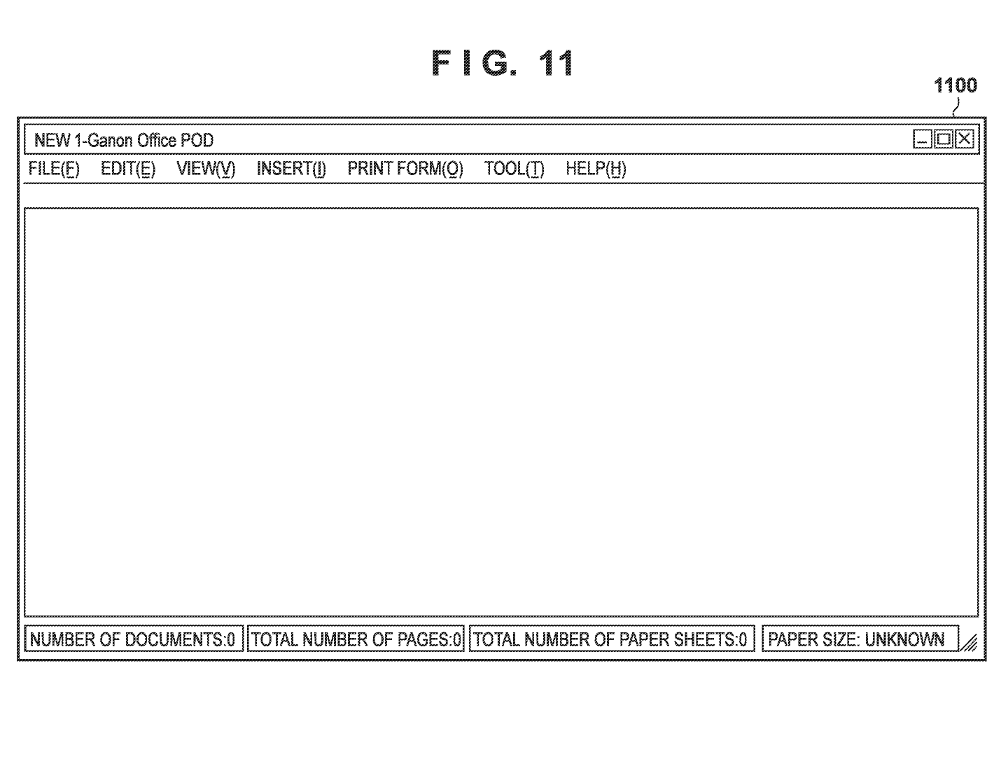

FIG. 11 shows an example of a UI screen 1100 when a book file is newly generated. In this case, the UI screen 1100 does not display any information corresponding to the contents of the book file because the book file does not have any substantial contents such as sections.

If there is an existing book file (NO in step S701), the bookbinding application 104 opens a designated book file and displays a UI screen in accordance with the structure, attributes, and contents of the book file (step S703).

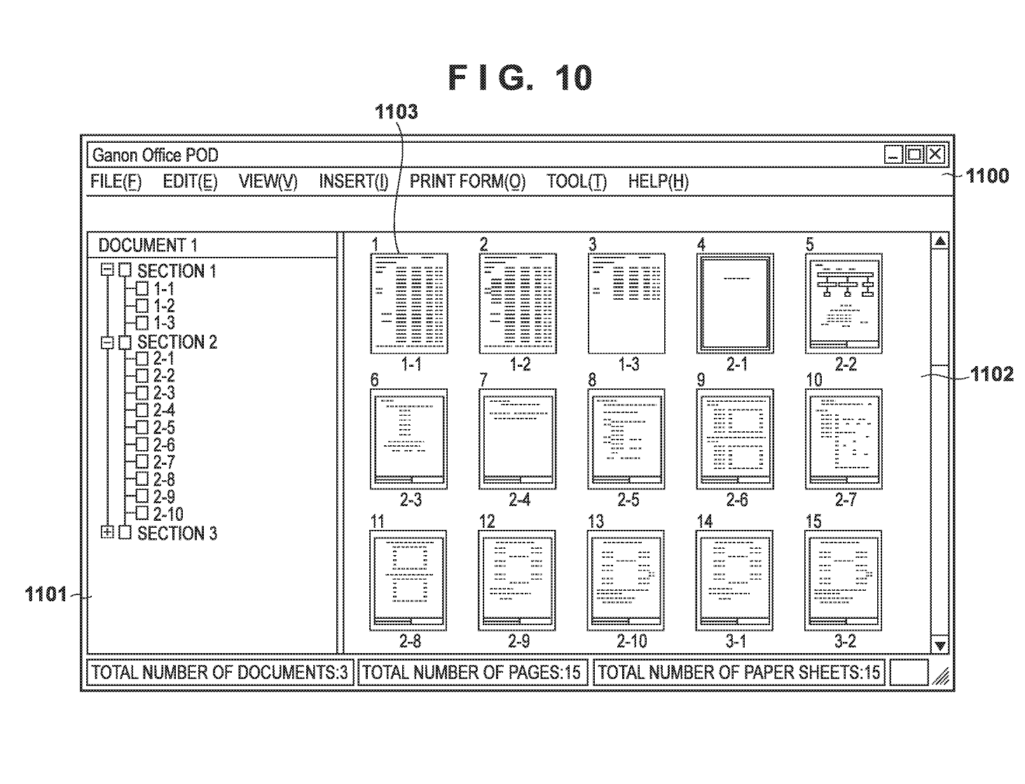

FIG. 10 shows an example of the UI screen 1100 displayed in step S703. The UI screen 1100 displays has a tree portion 1101 representing a book structure, and a preview portion 1102 displaying a printed state. The tree portion 1101 displays sections included in the book and pages included in each section by a tree structure, as shown in FIG. 3A. The tree portion 1101 displays page numbers. These page numbers indicate the numbers of document pages. The preview portion 1102 displays reduced print page contents. The display order reflects the book structure.

In the example shown in FIG. 10, the preview portion 1102 displays the page numbers (page counts) throughout the book at the upper left positions relative to the respective pages, and also displays sections to which the pages belong and the page numbers in the corresponding sections at the lower positions relative to the respective pages.

The electric document writer 102 can add application data converted into an electric document file as a new section to this opened book file. This function is called an “electric document import function”. It is possible to give an entity to a book file newly generated according to the procedure shown in the flowchart of FIG. 7 by adding a section by using this electric document import function. This function is activated by dragging and dropping application data on the screen in FIG. 10.

(Electric Document Import)

FIG. 8 is a flowchart showing an electric document import procedure. Note that this processing is implemented by making the CPU of the host computer 100, on which the bookbinding application 104 operates, read out programs from an HDD or the like as a storage unit.

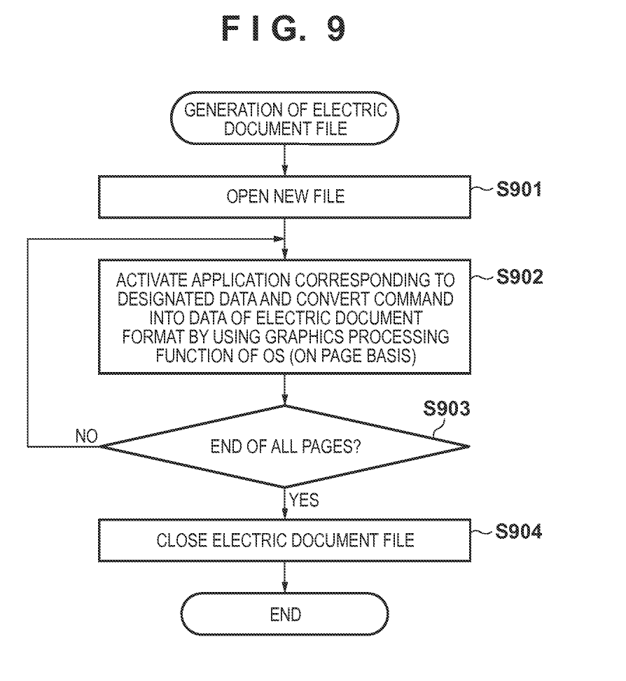

First of all, the bookbinding application 104 activates an application program which has generated designated application data. The bookbinding application 104 designates the electric document writer 102 as a device driver, and makes it print out application data to convert it into electric document data (step S801). The details of the processing in this step will be described later with reference to FIG. 9. After the conversion to this electric document data, the bookbinding application 104 determines in step S802 whether the converted data is image data. This determination can be performed based on the file extension of the application data under the Windows® OS. For example, the extension “bmp” represents Windows bitmap data; “jpg”, jpeg-compressed image data; and “tiff”, tiff-format image data. In the case of such image data, since it is possible to directly generate an electric document file from image data without activating the application unlike in step S801, it is possible to omit the processing in step S801

If the converted data is not image data (NO in step S802), the bookbinding application 104 adds the electric document file generated in step S801 as a new section to the book of a currently opened book file (step S803). In this case, as for section attributes, for attributes common to book attributes, the values of the book attributes are copied, and for the remaining attributes, default values prepared in advance are set.

if the converted data is image data (YES in step S802), no new section is added in principle, and the bookbinding application 104 adds each document page included in the electric document file generated in step S801 to a designated section (step S804). For a file in which a book file is newly generated, a new section is created, and each page of the electric document file is added as a page belonging to the section. As for page attributes, for attributes common to upper layer attributes, the attribute values of the upper layer are copied, and an attribute which is defined in application data and inherited to the electric document file is given a value defined in the application data. For example, when “N-up printing designation” is set in application data, the page inherits this attribute value. In this manner, a new book file is created, or a new section is added.

(Generation of Electric Document File)

FIG. 9 is a flowchart of a procedure of making the bookbinding application 104 generate an electric document file using the electric document writer 102 in step S801 shown in FIG. 8. Note that this processing is implemented by making the CPU of the host computer 100 read out programs from the HDD or the like as a storage unit.

First of all, in step S901, the bookbinding application 104 generates a new electric document file and opens it. The process then advances to step S902, and the bookbinding application 104 activates a general application 101 corresponding to designated application data, and sets the electric document writer 102 as a device driver to transmit an output command to the output module of the OS. The output module converts the received output command into data of the electric document format by the electric document writer 102, and outputs the converted data. The output destination is the electric document file opened in step S901. In this case, the data may be converted for each page. In step S903, the bookbinding application 104 determines whether all designated data have been converted. If the conversion is not complete (NO in step S903), the bookbinding application 104 repeats the conversion processing by the electric document writer 102 (step S902). If the conversion is complete (YES in step S903), the bookbinding application 104 closes the electric document file (step S904). The electric document file generated by the electric document writer 102 in this manner is a file containing document page data entities shown in FIG. 3B.

<Editing of Book File>

With the above processing, a book file can be generated from application data. The generated book file allows editing a section and page via the UI screen 1100 shown in FIG. 10 in the following manner:

(1) Adding new section or page

(2) Delete

(3) Copy

(4) Cut

(5) Paste

(6) Move

(7) Change section name

(8) Reassign page number/name

(9) Insert front cover

(10) Insert inserting paper

(11) Insert index paper

(12) Page layout of each document page

In addition, it is possible to perform the operation of canceling executed editing operation and the operation of redoing canceled operation.

These editing functions enable editing operations such as unification of a plurality of book files, rearrangement of sections and pages within a book file, deletion of sections and pages within a book file, layout change of a document page, and insertion of an inserting paper and index paper. Performing these operations will reflect the operation results in the attributes shown in FIGS. 4A to 6 or in the structure of the book file. For example, performing the operation of newly adding a blank page will insert the blank page into a designated portion. This blank page is handled as a document page. In addition, changing the layout of a document page will reflect the change contents in attributes such as the printing method, N-up printing, front cover/back cover, index paper, inserting paper, and section delimiting.

<Output of Book File>

The final purpose of a book file generated and edited in the above manner is to print it out. The user selects a file menu from the UI screen 1100 of the bookbinding application 104 shown in FIG. 10, and selects printing from this menu. A designated output device then prints the book file. At this time, the bookbinding application 104 generates a job ticket from a currently opened book file, and transfers the job ticket to the electric document despooler 105. The electric document despooler 105 converts the job ticket into an OS output command, for example, a Windows® GDI command, and transmits it to an output module (for example, GDI). The output module then causes the designated printer driver 106 generate a command complying with an output device (the printer 107 in this case) and transmits the command to the output device.

The job ticket is data with a structure whose minimum unit is a document page. The data structure of this job ticket defines the layout of a document page on a paper sheet. One job ticket is issued for one job. A document node is set on the top layer of the structure, and defines the attributes of the entire document such as double-sided printing/single-sided printing. A paper node belongs, as a subordinate node, to the document node, and contains attributes such as the identifier of a paper sheet to be used and designation of a feed port in the printer. A node for a sheet printed by the paper sheet belongs, as a subordinate node, to each paper node. One sheet corresponds to one paper sheet. One or two print pages (physical pages) belong to each sheet. One physical page belongs to one sheet in single-sided printing, and two physical pages belong to one sheet in double-sided printing. A document page to be laid out on a physical page belongs to each physical page. That is, one or a plurality of document pages are laid out on one physical page in accordance with settings such as N-up. The physical page attributes include a document page layout.

The electric document despooler 105 converts the above job ticket into an output command to the output module.

<Another System Configuration Example>

The document processing system of this embodiment has been outlined. This system is of a standalone type. A server-client system as an extension of the standalone system also generates and edits a book file by almost the same arrangement and procedure. A book file and print processing are managed by the server.

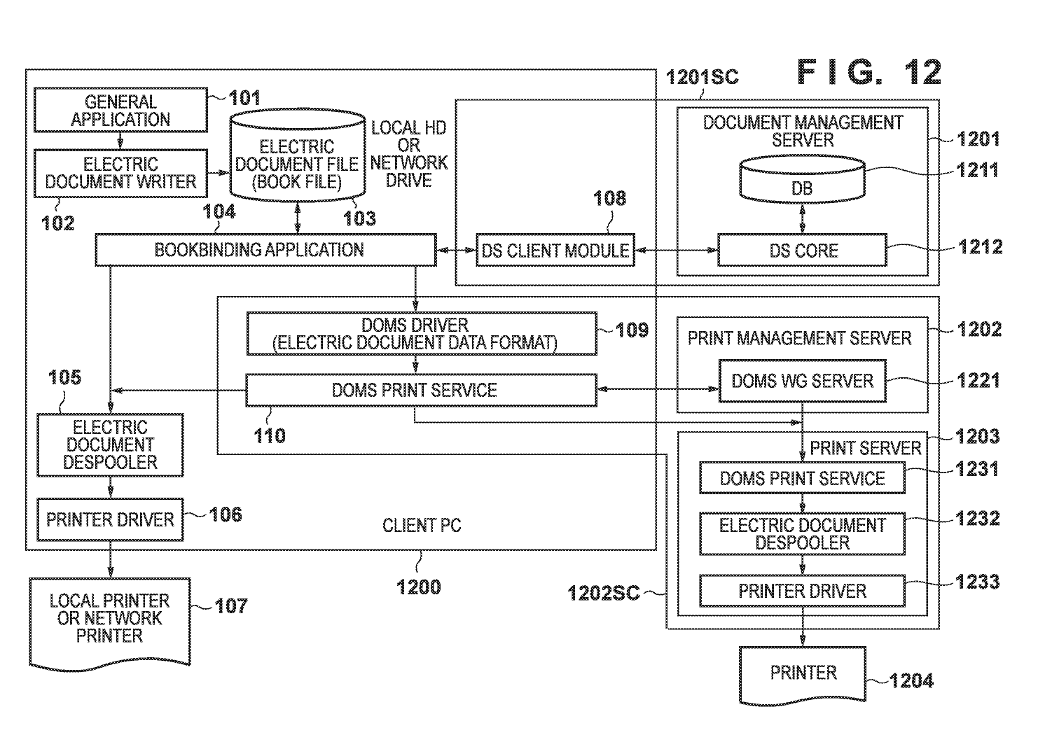

FIG. 12 is a block diagram showing the arrangement of a server-client type document processing system according to this embodiment. A client PC 1200 has an arrangement obtained by adding, to the standalone type system, a DOMS (Document Output Management Service) driver 109, a DOMS print service module 110, and a DS (Document Service) client module 108. The DOMS driver 109, the DOMS print service module 110, and the DS client module 108 are client modules. A document management server 1201, a print management server 1202, and a print server 1203 are communicatively connected to a client PC 1200. These servers are generally connected to the client PC 1200 via a network. When the servers also simultaneously function as clients, they are connected by interprocess communication which simulates communication between networks.

Although the document management server 1201 and the print management server 1202 are connected to the client in FIG. 12, only one of them may exist on the network. If, for example, the connected server is the document management server 1201, a document management server-client system 1201SC including the client module is added to the standalone type document management system. Likewise, if the connected server is the print management server 1202, a print management server-client system 1202SC including the client module is added to the standalone type document management system.

The document management server 1201 is a server which stores a book file generated and edited by the bookbinding application 104. When the document management server 1201 manages a book file, a database 1211 of the document management server 1201 saves the book file in instead of or in addition to the local HD of the client PC 1200. This system performs saving and reading of a book file between the bookbinding application 104 and the document management server 1201 via the DS client module 108 and a DS core 1212.

The print management server 1202 is a server which manages print processing of a book file saved in the client PC 1200 or stored in the document management server 1201. The client transmits a print request to a DOMS WG server module 1221 of the print management server 1202 via the DOMS driver 109 and the DOMS print service module 110. When printing a book file using the printer 107 of the client, the print management server 1202 transfers the book file to the electric document despooler 105 via the DOMS print service module 110 of the client PC 1200.

When printing via the print server 1203, the print management server 1202 transmits a book file to a DOMS print serve module 1231 of the print server 1203. For example, the print management server 1202 executes a security check on the qualification of a user who has issued a print request for a saved book file, or saves the print processing log. In this manner, the document processing system can be implemented as both the standalone system shown in FIG. 1 and the client-server system shown in FIG. 12.

<Contents of Preview Display>

As described above, when the bookbinding application 104 opens a book file, the user interface screen 1100 shown in FIG. 10 is displayed. The tree portion 1101 displays a tree representing the structure of the open book (to be referred to as a “book of interest” hereinafter). In the preview portion 1102, three display methods are prepared in accordance with designation by the user. The first display method is the “document view mode” of directly displaying a document page. In the “document view mode”, the contents of a document page belonging to the book of interest are reduced and displayed. The display on the preview portion 1102 does not reflect the layout on a print sheet of the document. The second display method is the “print view mode”. In this “print view mode”, the preview portion 1102 displays a document page which reflects the layout on a print sheet of the document page. The third display method is the “simple print view mode”. In this “simple print view mode”, the display on the preview portion 1102 reflects not the contents of each document page but only the layout on the print sheet.

Although the three display methods have been described above, the present invention is not limited to them, and may perform other display methods.

(Apparatus Arrangement)

Before the description of the features of the embodiment of the present invention, the arrangement of the document processing system including the host computer 100 and the printer 107, which can be applied to the embodiment, will be described next. Note that since the arrangement of the host computer 100 (to be referred to as a client hereinafter) is the same as that described with reference to FIG. 2, the same reference numerals denote common parts, and a description of them will be omitted. The embodiment can be applied to both cases in which the printer 107 is a local printer connected to a client and is a printer 1204 (FIG. 12) connected to a server.

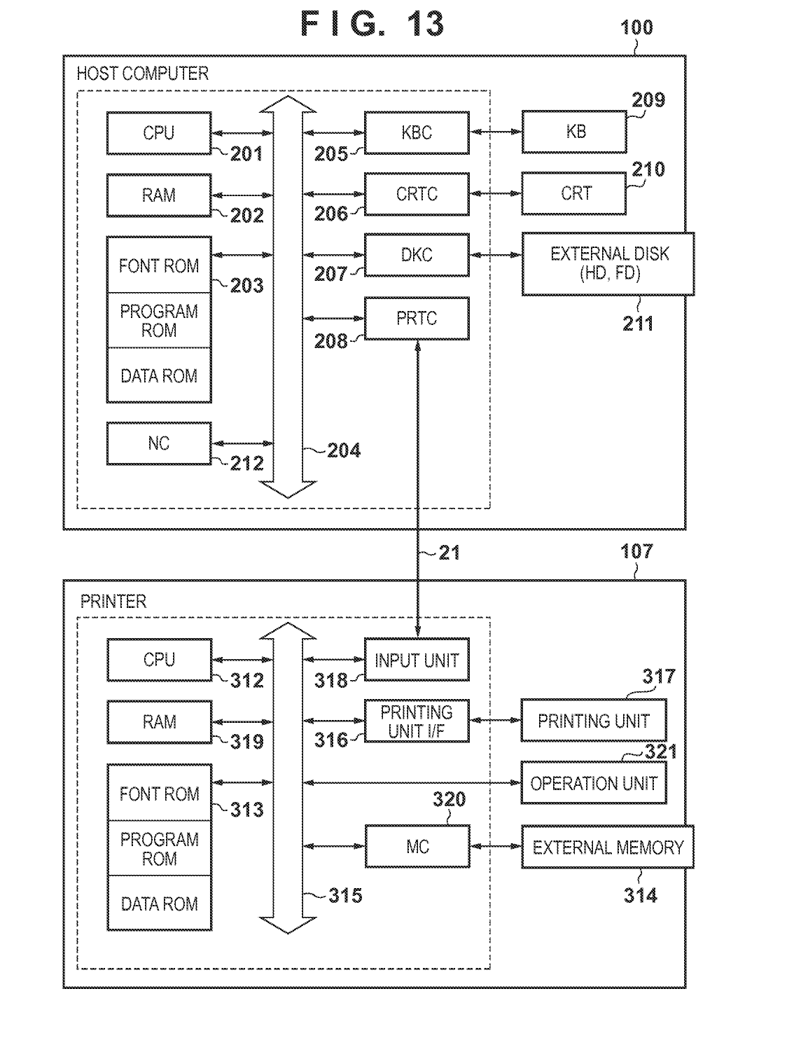

FIG. 13 is a block diagram for explaining an example of the arrangement of a document processing system according to the embodiment of the present invention. Note that the present invention can be applied to a single device, a system constituted by a plurality of devices, or a system which performs processing while being connected via a network such as a LAN or WAN as long as the functions of the embodiment can be implemented.

A CPU 312 controls the printer 107. The printer CPU 312 outputs an image signal as output information to a printing unit (printer engine) 317 based on a control program stored in the program ROM of a ROM 313 or a control program stored in an external memory 314 and loaded into a RAM 319. The program ROM of the ROM 313 stores the control program of the CPU 312. The font ROM of the ROM 313 stores font data and the like used to generate the output information. For a printer having no external memory 314 such as a hard disk, the data ROM of the ROM 313 stores information and the like used by the host computer 100.

The CPU 312 can communicate with the host computer 100 via an input unit 318 and notify the host computer 100 of the information and the like of the printer 107. The RAM 319 functions as a main memory, work area, and the like for the CPU 312, and can expand the memory capacity by an optional RAM connected to an expansion port (not shown). The RAM 319 is used as an output information mapping area, environment data storage area, NVRAM, or the like. The external memory 314 such as a hard disk (HD) or IC card is access-controlled by a memory controller (MC) 320. The external memory 314 is connected as an option, and stores font data, emulation programs, form data, and the like. An operation panel 321 includes operation switches, and LED indicators.

The external memory 314 is not limited to one, and the system may include a plurality of external memories. A plurality of external memories may be connected, which include an optional font card in addition to a built-in font card and store programs for interpreting the printer control languages of different language systems. In addition, the printer 107 may use an NVRAM (not shown) to store printer mode setting information from an operation panel 321.

Assume that in this case, as described with reference to FIG. 1, the host computer 100 includes the electric document file 103, the general application 101, the electric document despooler 105, and the printer driver 106. The electric document writer 102 generates the electric document file 103 from the document file (application data) generated by the general application 101. As described above, the bookbinding application 104 can open the electric document file 103. The bookbinding application 104 causes the CRT 210 to display, for example, the UI screen 1100 like that shown in FIG. 10 described above.

The bookbinding application 104 greatly differs from the general application 101 in that the bookbinding application 104 has a print setting function to be provided by the printer driver 106. With this print setting function, the bookbinding application 104 can make, for the electric document file 103, function settings in the printer 107, such as a stapling/punching function, in addition to editing functions of interchanging the page order of a document, copying, and deleting. Furthermore, the bookbinding application 104 can print by using the designated printer 107.

<Insertion of “Front Cover/Back Cover”, “Inserting Paper”, and “Index Paper”>

Paper feed setting processing in print processing according to this embodiment will be described next.

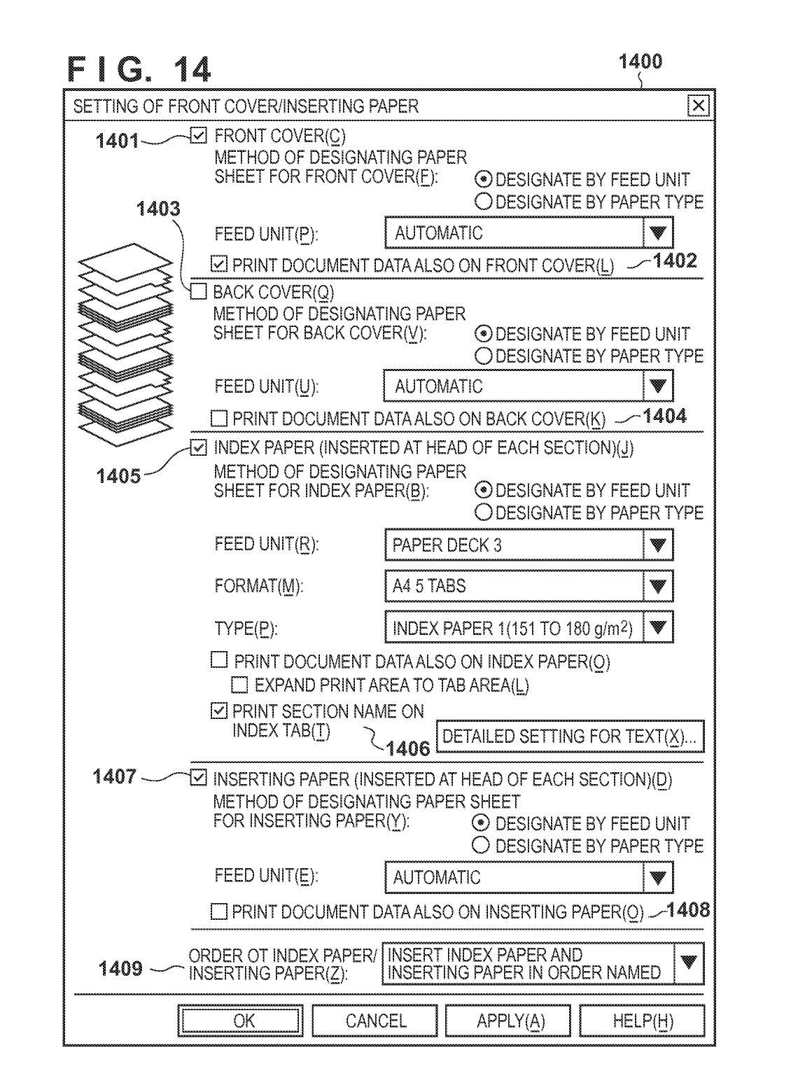

FIG. 14 shows an example of a UI screen 1400 which the bookbinding application 104 provides to allow to make settings for insertion/non-insertion of “front cover/back cover”, “inserting paper”, and “index paper” within one screen. Check boxes 1401, 1403, 1405, and 1407 allow to freely select a combination of insertion sheets which the user wants to insert in a document to be printed. Note that FIG. 14 shows an example of the screen configuration of the UI screen 1400, and the present invention is not limited to this. For example, the UI screen 1400 is configured to allow to make four settings for “front cover”, “back cover”, “inserting paper”, and “index paper”. However, this screen may be configured to allow to make settings for other types of paper in accordance with the function and the like of an image forming apparatus.

In the example shown in FIG. 14, since the check box 1401 of “front cover” is checked, the user has issued an instruction to insert a “front cover” at the head of a document. In this case, the user can set a method of inserting a paper sheet serving as a front cover. Assume that the user can set either insertion by “inserter” or insertion from “feed unit”. When the user sets insertion by “inserter”, the system takes in a sheet prepared in advance from outside and sets it as a front cover (does not print on the front cover in this case). When the user sets insertion from “feed unit”, the feed unit feeds a paper sheet, and the system prints the first page of a print document on the paper sheet as a front cover. In the example shown in FIG. 14, since the user has issued an instruction to insert a front cover and checked a check box 1402 of “print document data also on front cover”, the feed unit feeds a paper sheet, and the system prints on the paper sheet as a front cover.

In addition, in the example shown in FIG. 14, the user has checked a check box 1403 of “back cover” to issue an instruction to insert a “back cover” at the end of the document. As in the case of “front cover”, therefore, the user can select either insertion of a paper sheet serving as a “back cover” by “inserter” or insertion from “feed unit”. In the case in FIG. 14, since the user has not checked a check box 1404 of “print document data also on back cover” although he/she has designated insertion of a back cover, the system does not print on the back cover.

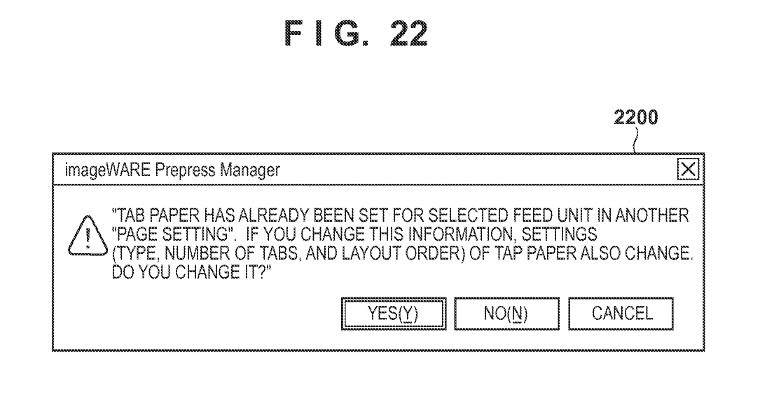

In the example shown in FIG. 14, the user has checked the check box 1405 of “index paper” to issue an instruction to insert “index paper” in the document. In this case, the system inserts index paper in front of the first page of each section displayed on the tree portion 1101 in FIG. 10. In addition, the user has checked a check box 1406 of “print name of section on tab of index paper”. This makes it possible to designate to print the name of each section displayed on the tree portion 1101 in FIG. 10 (stored as the setting information of each section (FIG. 22)) on the tab of index paper. In the example shown in FIG. 14, since the user has checked a check box 1406 of “print document data on index paper”, the system prints the name of each section on the tab of index paper.

Note that when the user has issued an instruction to insert index paper, the user can also set detail information concerning the index paper (for example, the feed unit and the form and the type of index paper) as indicated by the UI screen 1400.

In the example shown in FIG. 14, the user has checked a check box 1407 of “inserting paper” to issue an instruction to insert “inserting paper” in the document. In this case, the system inserts inserting paper in front of the first page of each section displayed on the tree portion 1101 in FIG. 10. In this case, since the user has not checked a check box 1408 of “print document data also on inserting paper”, the system does not print on the inserting paper.

In the example shown in FIG. 14, “order of index paper/inserting paper” 1409 is an area for instructing the insertion order of “index paper” and “inserting paper” to be inserted at the head of each section of insertion sheets. This area is effective only when both the check boxes 1405 and 1407 are checked. In the example shown in FIG. 14, since the user has selected “insert index paper and inserting paper in order named”, the system inserts index paper and inserting paper at the head of each section in the order named.

Note that the “front cover”, “back cover”, “index paper”, and “inserting paper” designated on the UI screen 1400 do not exist as actual document data in the electric document file and are managed as print setting information in the electric document file. For this reason, only changing print settings on the UI screen 1400 (unchecking check boxes or changing tags) allows the user to insert or delete a “front cover”, “index paper”, “inserting paper”, and “back cover”.

As described above, the bookbinding application 104 according to the present invention makes the user select, in a check box form, whether to insert the types of paper (for example, front and back covers) whose insertion positions in a document are uniquely determined. The bookbinding application 104 makes the user select both “ON/OFF” in a check box form and an insertion order for only the types of paper (for example, index paper and inserting paper) which are to be plurally inserted in a document. This allows the user to designate insertion of a plurality of types of insertion sheets with easy operation in all “combinations” and “orders”

In addition, the display contents of options concerning insertion orders are narrowed down in accordance with “ON/OFF” of check boxes. This limits the display of the options concerning insertion orders to the minimum to allow the user to easily select options even if the number of types of insertion sheets increases in the future.

(Setting Processing)

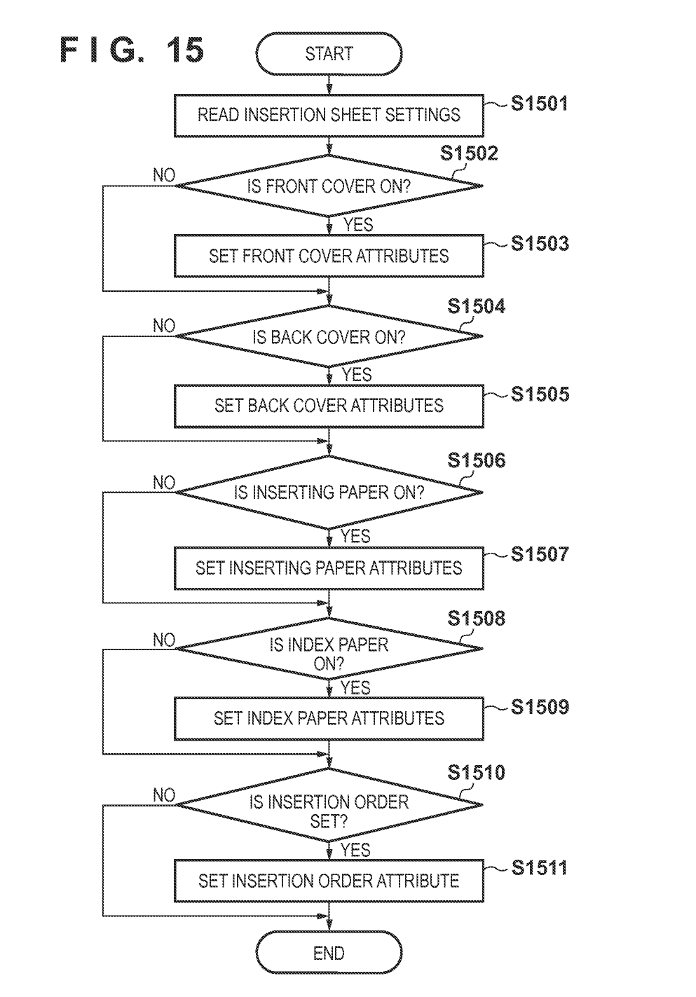

FIG. 15 explains the processing of causing the bookbinding application 104 to reflect the contents set on the UI screen 1400 for “paper insertion setting”, described with reference to FIG. 14, in the book attributes of a book file. Each step of the flowchart according to the present invention is implemented by making the CPU of the host computer 100, on which the bookbinding application 104 operates, read out programs from an HDD or the like as a storage unit.

In step S1501, the bookbinding application 104 reads the insertion sheet setting information set by the user on the UI screen 1400 in FIG. 14. In step S1502, the bookbinding application 104 determines whether the user has issued an instruction to insert a “front cover” in the check box 1401. If the user has issued an instruction to insert a “front cover” (YES in step S1502), the bookbinding application 104 sets “front cover” attribute of the book attributes of the book file (step S1503). If the user has not issued an instruction to insert a “front cover” (NO in step 1502), or the system has completed the processing of reflecting in the book attributes in step S1503, and the process advances to step S1504. In step S1504, the bookbinding application 104 determines whether the user has issued an instruction to insert a “back cover” in the check box 1403. If the user has issued an instruction to insert a “back cover” (YES in step S1504), the bookbinding application 104 sets the “back cover” attribute in the book attributes of the book file (step S1505).

The bookbinding application 104 performs the same setting processing for the “inserting paper” and “index paper” attributes in accordance with values set on the UI screen 1400 in FIG. 14 (steps S1506 to S1509). The process then advances to step S1510. In step S1510, the bookbinding application 104 determines whether the user has designated the insertion order of “index paper” and “inserting paper” in the area 1409 on the UI screen 1400 in FIG. 14. If the user has designated an insertion order (YES in step S1510), the system sets the insertion order attribute in the book attributes (step S1511). The bookbinding application 104 completes the processing of reflecting the contents of “paper insertion settings” in the book attributes of the book file.

As described above, the bookbinding application 104 according to the present invention allows to change the insertion order of index paper and inserting paper on a section basis when the user has designated insertion of index paper and inserting paper in a document. This improves the degree of freedom of insertion sheet settings

<Change of Output Sheets on Page Basis>

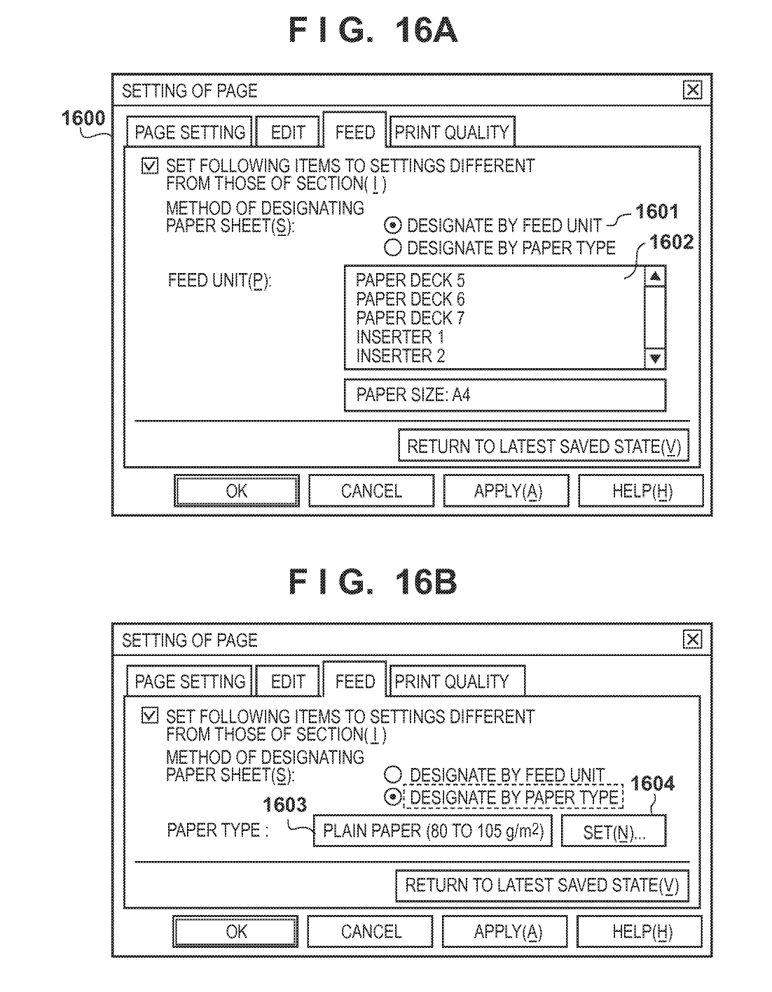

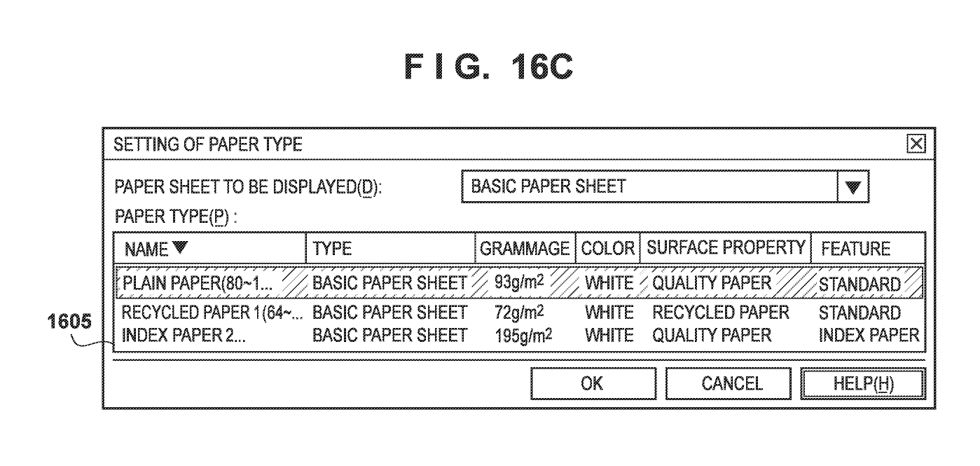

The bookbinding application 104 can also change output sheets on a page basis by using a page setting screen 1600 shown in FIGS. 16A to 16C. The user can open the page setting screen 1600 by selecting and right-clicking an arbitrary page on the tree portion 1101 or the preview portion 1102. The page setting screen 1600 includes radio buttons 1601 which allow the user to select a paper designation method for printing the page from “designation by feed unit” and “designation by paper type”.

FIG. 16A shows a case in which the user has designated “designation by feed unit” as a paper designation method. In this case, the page setting screen 1600 displays a list of paper feed trays which can be used in the selected device. The user can designate a desired paper feed tray, on the displayed list, from paper decks or inserters storing paper sheets on which the user wants to print the page. When the user designates a paper feed tray from the list displayed in a feed unit area 1602, the bookbinding application 104 gives the selected paper feed tray information as paper feed unit attribute contained in the page attributes of the page, and holds the resultant data as a job ticket in the book file.

FIG. 16B shows a case in which the user has designated “designation by paper type” as a paper designation method. Referring to FIG. 16B, when the user presses a set button 1604, the bookbinding application 104 displays the paper type setting screen shown in FIG. 16C. The bookbinding application 104 displays, in a paper type area 1605 in FIG. 16C, a list of paper sheets which can be used by a selected device. The user can change an output sheet by selecting the name of a paper sheet which the user wants to use for printing the page. The bookbinding application 104 displays the type of paper selected in the paper type area 1605 in FIG. 16C in a combo box 1603 for the types of paper in FIG. 16B. When the user selects the paper sheet on the paper type setting screen in FIG. 16C, the bookbinding application 104 gives the selected paper sheet information as paper type attribute contained in the page attributes of the page, and holds the resultant data as a job ticket in the book file.

In this manner, the bookbinding application 104 according to the present invention allows to change output sheet attributes on a page basis, thereby facilitating print settings for a combination of various types of paper other than insertion sheets.

<index Paper Designation on Page Basis>

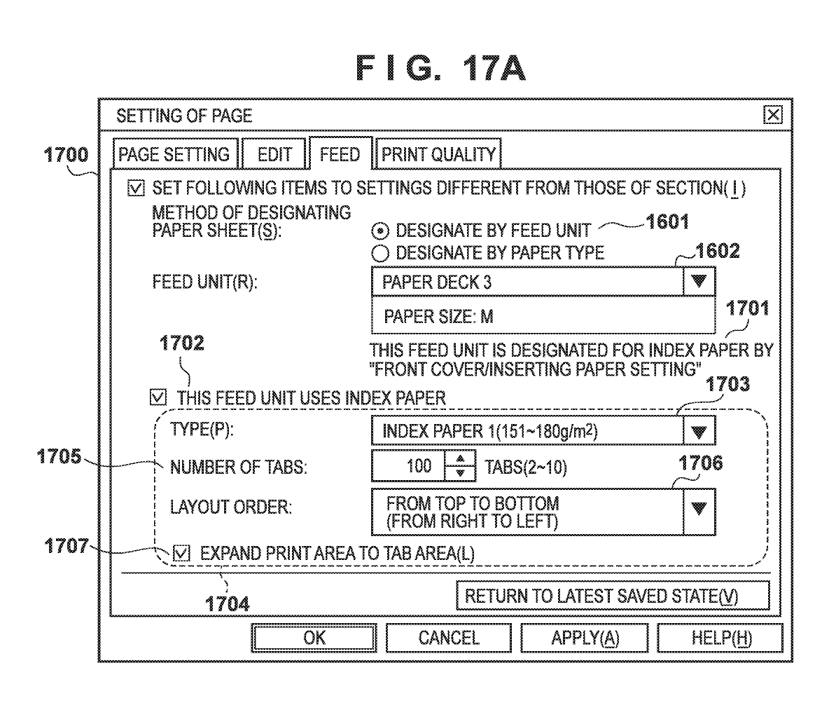

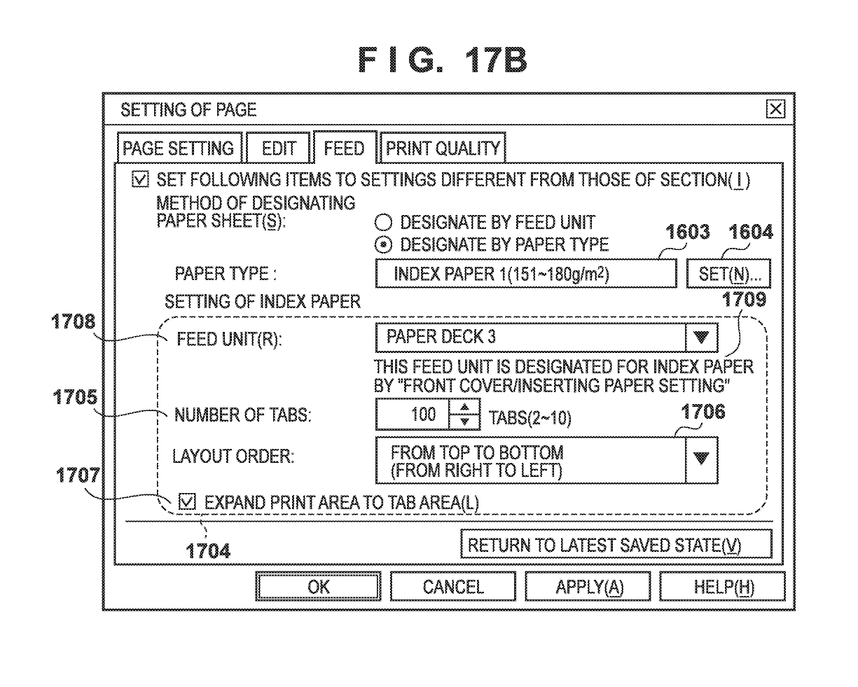

FIGS. 17A and 17B are views showing an example of the screen obtained by expanding the page setting screen 1600 shown in FIGS. 16A to 16C. This screen serves as an accepting unit which accepts settings from the user, and is displayed on the CRT 210 of the host computer 100.

The bookbinding application 104 according to this embodiment provides a page setting screen 1700 expanded in the manner shown in FIGS. 17A and 17B to facilitate making settings for printing a desired page as index paper. The page setting screen 1700 shown in FIGS. 17A and 17B is also displayed when the user selects an arbitrary page on the tree portion 1101 or the preview portion 1102 in FIG. 10 and performing right clicking operation.

(When Paper Designation Method is Designation by Feed Unit)

FIG. 17A is a view showing an example when the user has designated “designation by feed unit” as a paper designation method on the page setting screen 1700. When the user designates “designation by feed unit” as a paper designation method with the radio button 1601, the bookbinding application 104 displays the page setting screen 1700 in FIG. 17A.

A guidance sentence 1701 serves to prevent the user from setting different pieces of index paper information (the types, the number of tabs, and the like of index paper) with respect to the same cassette in one book file. More specifically, the user selects the first page in FIG. 10, and designates “10” as the number of tabs as index paper information upon selecting paper deck 3. Subsequently, the user selects the fourth page in FIG. 10, and selects “paper deck 3” to prevent the user from designating “5” as the number of tabs as index paper information. The bookbinding application 104 displays the guidance sentence 1701 when the user has already set the feed unit selected in the feed unit area 1602 as a feed unit for index paper on the page setting screen 1700 for another page or the UI screen 1400 in FIG. 14.

A check box 1702 of “this feed unit uses index paper” is a check box for setting whether to use the page as a page for index paper. Checking the check box of this setting (the check box is ON) will make the system perform printing processing by using this page as index paper. That is, in this case, the bookbinding application 104 can generate drawing data for a portion corresponding to the tab of index paper (the tab portion of index paper). If the check box 1702 is OFF, the system does not perform print processing by using the corresponding page as index paper. In this case, even if index paper is set on the paper feed tray selected in the feed unit area 1602, the system does not print on the tab portion.

A detailed setting area 1704 for performing detailed setting for index paper becomes a settable state when the check box 1702 is ON. A combo box 1703 of “type” is a combo fox for setting the type of index paper. In this case, it is possible to select all types of index paper which can be used in the selected printer. A spin box 1705 of “number of tabs” is a spin box for designating the number of tabs of index paper selected with the combo box 1703. A combo box 1706 of “order” is a combo box for setting the printing order of text data printed on tabs. This combo box allows to select a printing order from “from top to bottom (from right to left)” and “from bottom to top (from left to right)”. A check box 1707 of “expand printing area to tab area” is a check box for setting whether to also print the tab portion of index paper, when the corresponding page includes drawing data corresponding to the tab portion of the index paper. If, for example, the page selected in FIG. 10 is constituted by drawing data corresponding to the A4 portion and drawing data corresponding to the tab portion, generating print data while keeping the print area as an A4 area as in a general case will lack in drawing data to be printed on the tab portion. Expanding the print area by validating the check box 1707 makes it possible to also print drawing data on the tab portion of the index paper. Note that the setting of the check box 1707 is validated only when the setting of the check box 1702 is ON.

(When Paper Designation Method is Designation by Paper Type)

FIG. 17B is a view showing an example when the user has designated “designation by paper type” as a paper designation method on the page setting screen 1700. When the user designates “designation by paper type” as a paper designation method with the radio button 1601, the bookbinding application 104 displays the page setting screen 1700 in FIG. 17B.

In the case shown in FIG. 17A, only when the check box 1702 of “this feed unit uses index paper” is ON, it is possible to perform detailed setting for index paper with the detailed setting area 1704. In contrast to this, in the case shown in FIG. 17B, only when the user presses the set button 1604 and selects index paper on the screen in FIG. 16C, it is possible to perform detailed setting for index paper with the detailed setting area 1704. Referring to FIG. 17B, the functions of spin box 1705, combo box 1706, and check box 1707 are the same as those in FIG. 17A, and hence a description of them will be omitted.

A combo box 1708 is a combo box for setting a feed unit which feeds index paper selected with a paper type. FIG. 17B shows a case in which the user has selected “paper deck 3”. A guidance sentence 1709 has the same purpose as the guidance sentence 1701 in FIG. 17A. The bookbinding application 104 displays the guidance sentence 1709 when the feed unit selected with the combo box 1708 has already been set as a feed unit for index paper on the page setting screen 1700 for another page or the UI screen 1400 in FIG. 14.

(Display Processing)

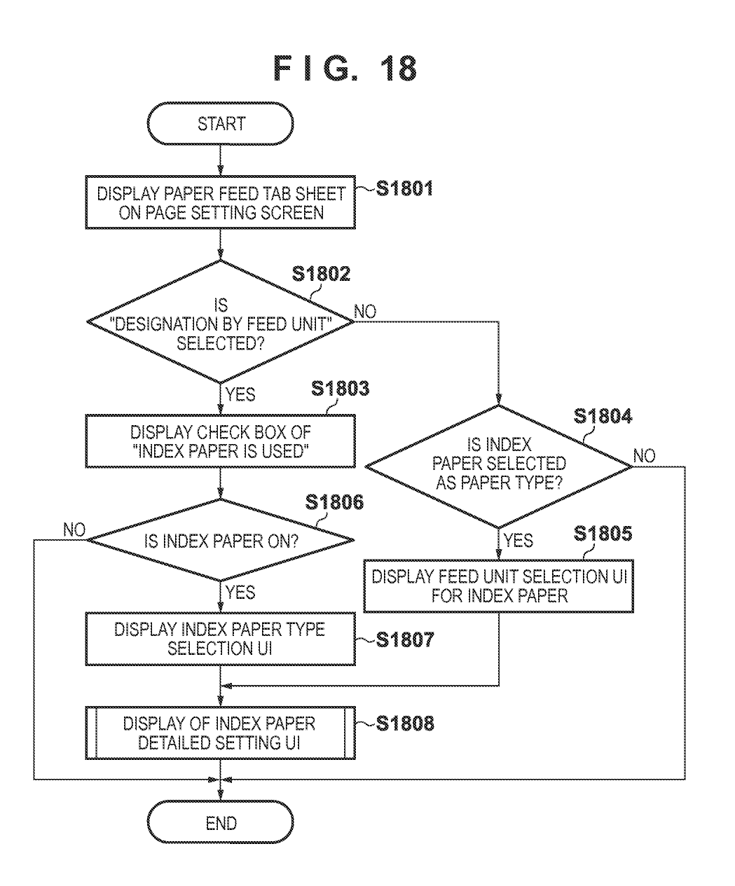

FIG. 18 is a flowchart for explaining display control processing on the page setting screen 1700 in FIGS. 17A and 17B in the bookbinding application 104.

For example, when the user selects a page number displayed on the tree portion 1101 of the UI screen 1100 shown in FIG. 10, opens the page setting screen 1700 by right clicking, and selects a paper feed tab, the system start this processing. When the user performs the above operation, the bookbinding application 104 displays the page setting screen 1700 described with reference to FIGS. 17A and 17B (step S1801). The bookbinding application 104 determines whether the user has selected “designation by feed unit” with the corresponding radio button 1601 for the paper feed designation method on the page setting screen 1700 (step S1802). If the user has selected “designation by feed unit” (YES in step S1802), the bookbinding application 104 displays the check box 1702 of “this feed unit uses index paper” on the page setting screen 1700 (step S1803)

Subsequently, the bookbinding application 104 determines whether the check box 1702 is ON (step S1806). If the check box 1702 is ON (YES in step S1806), the bookbinding application 104 displays the combo box 1703 of “type” for making the user select the type of index paper (step S1807). Finally, the bookbinding application 104 displays the setting items of various settings for detailed setting for index paper in a selectable state on the page setting screen 1700 (step S1808). In this case, the displayed setting items include, for example, the spin box 1705 of “number of tabs”, the combo box 1706 of “order”, and the check box 1707 of “expand print area to tab area”. Thereafter, the bookbinding application 104 terminates the display processing for the page setting screen.

In contrast, if the bookbinding application 104 determines that the user has not selected “designation by feed unit” (that is, has selected “designation by paper type”) (NO in step S1802), the process advances to step S1804. In step S1804, the bookbinding application 104 determines whether the user has selected index paper with the combo box 1603 of “paper type”. If the user has selected index paper (YES in step S1804), the bookbinding application 104 displays, on the page setting screen 1700, the combo box 1708 of “feed unit” for making the user select a feed unit for index paper (step S1805). The bookbinding application 104 then displays setting items for performing detailed setting for index paper on the page setting screen 1700 so as to allow the user to select (step S1808). The setting items displayed in this case include the spin box 1705 of “number of tabs”, the combo box 1706 of “order”, and the check box 1707 of “expand print area to tab area”. The bookbinding application 104 then terminates the display processing for the page setting screen. Upon determining that the user has not selected any index paper (NO in step S1804), the bookbinding application 104 terminates the display processing for the page setting screen.

As described above, the bookbinding application 104 automatically switch and display remaining setting items concerning index paper for the respective cases in which “designation by feed unit” is selected as a paper designation method and “designation by paper type” is designated as a paper designation method. With this operation, when the user makes settings for printing a specific page as index paper, it is possible to set information necessary for printing on index paper without omission, regardless of whether the user selects either “designation by feed unit” or “designation by paper type” as a paper designation method.

<Automatic Index Paper Detailed Setting>

Allowing to make settings for each page included in one book file may cause the bookbinding application 104 to set detail information for different pieces of index paper (the types, the numbers of tabs, and the like of index paper) with respect to the same cassette. In order to prevent this, the system includes a function of changing the contents of initial settings in the detailed setting area 1704 for index paper in accordance with the selected contents of “feed unit” on the page setting screen 1700.

(Index Paper Information Table)

The index paper information table managed by the bookbinding application 104 will be described first. The bookbinding application 104 includes a table (index paper information table 1900) holding sets of information of feed units designated in a book file and index paper setting information corresponding to the feed units. The bookbinding application 104 is configured to manage the index paper information table 1900 so as to prevent detail information of different pieces of index paper from being set for the same cassette in a book file.

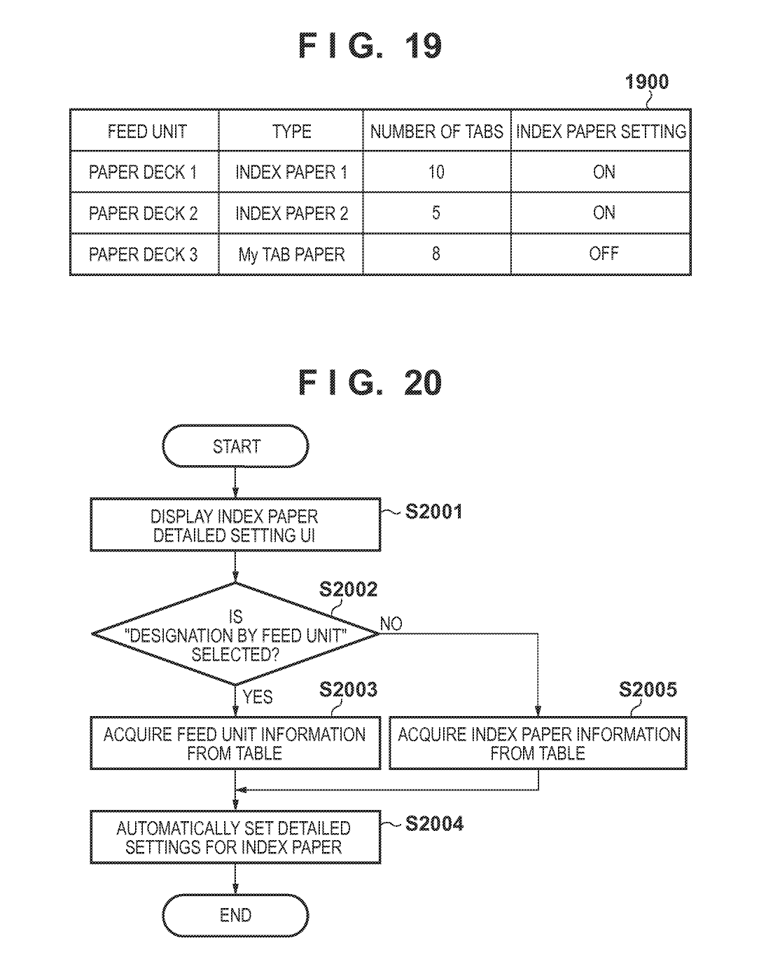

FIG. 19 is a view showing an example of the arrangement of the index paper information table 1900 managed by the bookbinding application 104. Referring to FIG. 19, this table holds information concerning a plurality of feed units of the printing apparatus and detail information of pieces of index paper which the respective feed units can feed, in association with each other. In this case, types, the numbers of tabs, and index paper settings are set as detail information of index paper. In this case, the index paper setting indicates whether the corresponding feed unit is used to feed index paper.

Note that the values set in the index paper information table 1900 are the initial values displayed in the detailed setting area 1704. This system may update the values registered in the index paper information table in accordance with instructions from the user or the like.

In addition to the index paper information table 1900, the system may hold a table concerning other pieces of paper information such as information concerning paper sheets used as inserting paper (slip sheets) and information concerning paper sheets used as front and back covers.

(UI Display Processing)

FIG. 20 is a flowchart of UI display processing for detailed settings for index paper in step S1808 described above. FIG. 20 is a flowchart for explaining the processing of making the bookbinding application 104 automatically set initial setting contents in the detailed setting area 1704 for index paper in accordance with the selected contents of “feed unit” on the page setting screen 1700.

First of all, in step S2001, the bookbinding application 104 displays the detailed setting area 1704 for index paper on the page setting screen 1700. In step S2002, the bookbinding application 104 determines whether the user has selected “designation by feed unit” as a paper feed method. If the user has selected “designation by feed unit” (YES in step S2002), the bookbinding application 104 acquires information such as the type and the number of index paper and the like corresponding to the currently selected paper feed tray from the index paper information table 1900 (step S2003).

If the user has not selected “designation by feed unit” (NO in step S2002), the bookbinding application 104 acquires information such as the type and the number of index paper and the like corresponding to the currently selected type of index paper from the index paper information table 1900 (step S2005). Note that having not selected “designation by feed unit” is equivalent to having selected “designation by paper type”. In step S2004, the bookbinding application 104 decides initial setting contents in the detailed setting area 1704 for index paper based on the information acquired from the index paper information table 1900 and automatically sets the contents on the page setting screen 1700. When the user selects a paper feed tray in the feed unit area 1602 in FIG. 17A or the combo box 1708 in FIG. 17B, the bookbinding application 104 refers to FIG. 19. If information concerning index paper has been set for the selected paper feed tray, the bookbinding application 104 displays the guidance sentence 1701 or 1709. In the case shown in FIG. 17A, for example, the user has selected “paper deck 3” as a feed unit and information concerning “index paper” is set for paper deck 3 in FIG. 19, the guidance sentence 1701 is displayed.

In the above manner, the bookbinding application 104 automatically sets setting items in the detailed setting area 1704 for index paper in accordance with the setting contents in the paper feed method area on the page setting screen by the user. More specifically, after the user sets the contents shown in FIG. 17A for a given page, the contents in FIG. 17A are then displayed for another page, and the paper deck 3 is selected. In this case, the bookbinding application 104 displays detail information of index paper in paper deck 3 which has already been set. This allows the user to save the trouble of setting, and can prevent the user from erroneously setting different pieces o index paper information for the same cassette in a book file.

<Index Paper Information Table Update Processing>

The bookbinding application 104 has a function of preventing the user from setting different pieces of index paper information (the type, the number of tabs, and the like of index paper) for one paper feed tray in a book file. This function displays a warning screen when the user changes settings from the initial setting contents in the detailed setting area 1704 for index paper. In this case, the bookbinding application 104 updates the index paper information table only when receiving a permission to change by the user on the warning screen.

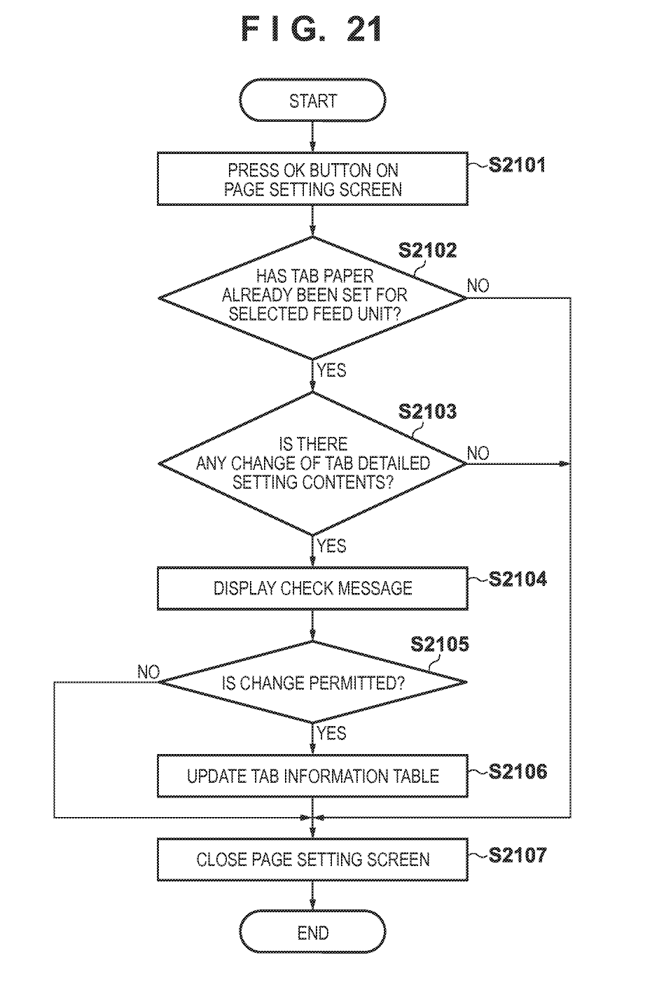

FIG. 21 is a flowchart for explaining update processing for the index paper information table 1900 of the bookbinding application 104.

When the user presses the OK button on the page setting screen 1700, the bookbinding application 104 accepts the operation of closing the page setting screen (step S2101). In step S2102, the bookbinding application 104 refers to the index paper information table 1900. The bookbinding application 104 then determines whether index paper has already been set for the feed unit selected on the page setting screen 1700 from which a signal from the OK button has been accepted. If index paper has been set for the selected feed unit (YES in step S2102), the bookbinding application 104 determines whether the setting content in the detailed setting area 1704 has been changed from the initial setting contents in step S2004 in FIG. 20 (step S2103). In this case, the bookbinding application 104 determines that the initial setting contents have been changed, if there is a difference between the contents of the index paper information table 1900 and the setting contents in the detailed setting area 1704.

Upon determining that there is a change from the initial setting contents (YES in step S2103), the bookbinding application 104 displays, on the screen, a check message for checking whether to change the settings (step S2104). FIG. 22 is a display example of a check message screen 2200 displayed by the bookbinding application 104. The screen 2200 in FIG. 22 includes buttons for accepting user's instructions to permit and inhibit update. When the user presses the “YES” button on the screen 2200 (YES in step S2105), the bookbinding application 104 updates the information of the index paper information table 1900 according to the contents set in the detailed setting area 1704 on the page setting screen (step S2106). The bookbinding application 104 then closes the page setting screen (step S2107). Thereafter, the bookbinding application 104 terminates this processing.

if the user presses the “NO” button on the screen 2200 (NO in step S2105), the bookbinding application 104 advances to step S2107 without changing the contents of the index paper information table 1900, and closes the page setting screen 1700.

In addition, upon determining that there is no change from the initial setting contents (NO in step S2103), the bookbinding application 104 advances to step S2107 without changing the contents of the index paper information table, and closes the page setting screen.

In this manner, the bookbinding application 104 manages the state of settings according to the index paper information table so as to always narrow down setting information for index paper for each paper feed tray to one kind in a book file. This prevents the user from erroneously setting a plurality of pieces of index paper information for one paper feed tray.

<Processing of Prevention of Different Settings for One Cassette>

The page setting screen 1700 shown in FIGS. 17A and 17B allows to explicitly set a text (that is paper other than index paper) or index paper for each page. This may lead to settings which contradict each other in terms of a job, for example, setting “index paper” for a given page and “text” for another page with respect to one paper feed tray. In order to prevent this, the bookbinding application 104 has a function of preventing overlapping settings for a text and index paper with respect the same paper feed tray.

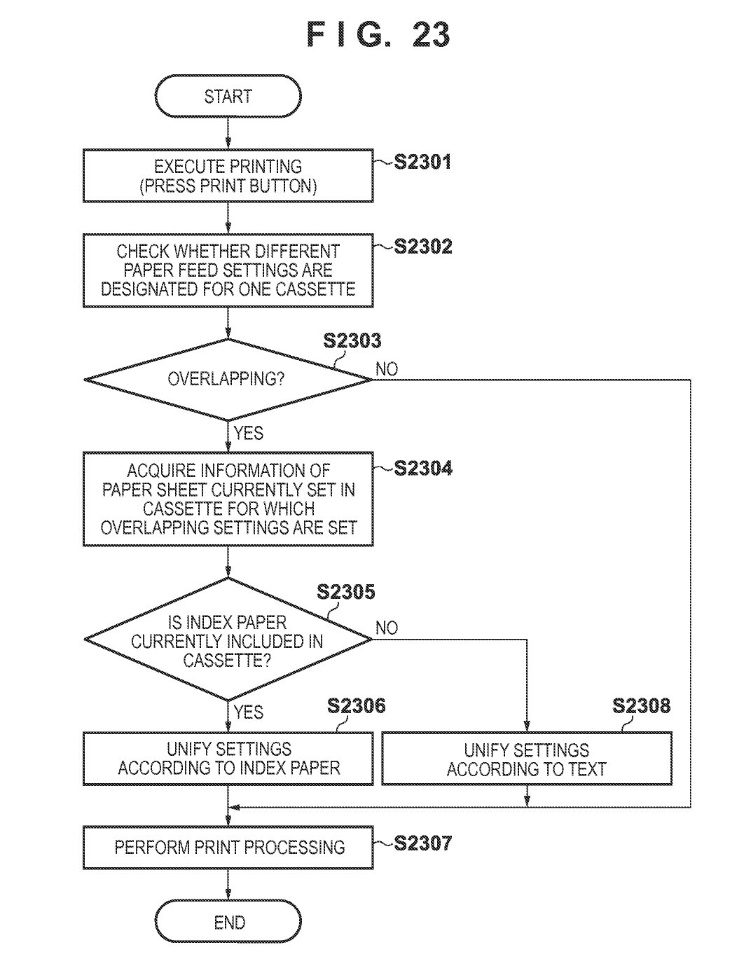

FIG. 23 is a flowchart for explaining the processing of making the bookbinding application 104 prevent overlapping settings for a text and index paper with respect to one paper feed tray.

The bookbinding application 104 accepts an instruction to execute print processing of the book file from the user (step S2301). The bookbinding application 104 then checks whether there are overlapping settings for a text and index paper with respect to the same paper feed tray in the book file (step S2302). If there are overlapping setting contents with respect to a specific paper feed tray (YES in step S2303), the bookbinding application 104 acquires, from the printer 107, paper information (information of paper sheets currently set in the paper feed tray) concerning the paper feed tray to which the overlapping settings are set (step S2304). The bookbinding application 104 then determines whether index paper is currently set in the paper feed tray (step S2305).

If index paper is currently set in the paper feed tray (YES in step S2305), the bookbinding application 104 unifies the page attributes of all the pages for which the paper feed tray has been selected to the “index paper” attribute (step S2306). The bookbinding application 104 then starts print processing (step S2307). If paper other than index paper is set (NO in step S2305), the bookbinding application 104 unifies the page settings of all the pages for which the paper feed tray has been selected to “text” (step S2308). The bookbinding application 104 then starts print processing (step S2307).

Upon determining that there are no overlapping settings (NO in step S2303), the bookbinding application 104 starts print processing in step S2307. Note that the print processing indicates the processing of making the bookbinding application 104 issue an instruction to generate print data to the printer driver 106.

If the user has made overlapping settings, that is, settings for “index paper” and “text”, for the same cassette at the time of execution of printing, the bookbinding application 104 acquires the paper information currently set for the cassette from the output device. The bookbinding application 104 then automatically changes print settings so as to set only the settings for “index paper” or “text”. This makes it possible to prevent the state of settings which contradict each other in terms of a job, such as setting “index paper” for a given page and an “text” for another page with respect to the same cassette.

<Preview Discriminating Types of Index Paper>

In general, a plurality of pieces of index paper constitute a group. The bookbinding application 104 therefore displays pieces of index paper for each group. When a plurality of types of index paper are set for a book file, the bookbinding application 104 displays them so as to allow to identify each group of index paper.

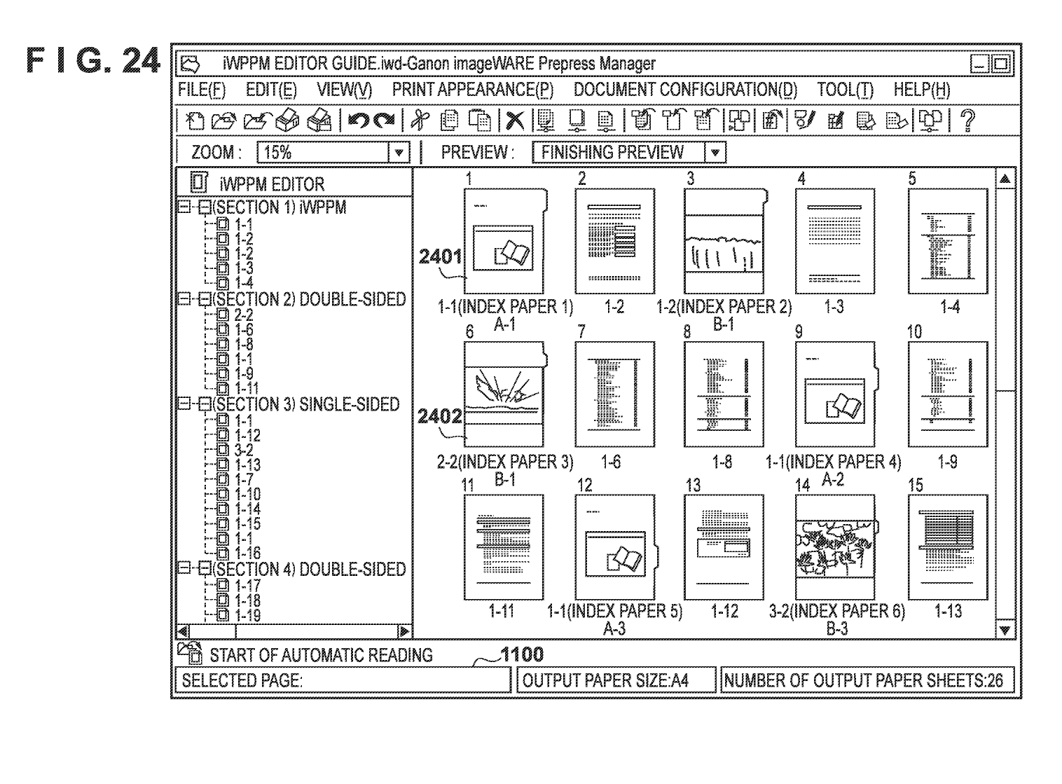

FIG. 24 is a view showing an example of displaying, when a plurality of types of index paper are set, these pieces of index paper so as to allow to identify each type group. FIG. 24 shows an example of setting two types of index paper, that is, 5-tab index paper and 7-tab index paper, for a book file. In this example, of the pages constituting the book file, the first, ninth, and 12th pages belong to a 5-tab index paper group, whereas the third, sixth, and 14th pages belong to a 7-tab index paper group.

A preview 2401 is a preview display example when index paper is set and the number of tabs is set to “5” on the page setting screen 1700 for the first page. This page displays a character string “A” indicating a type group of index paper below the page, and “1” indicating that the corresponding index paper is the first index paper among “A”. A preview 2402 is a preview display example when index paper with the number of tabs being set to “7” on the page setting screen 1700 for the sixth page. Obviously, this page displays a character string “B” indicating the type group of index paper below the page, and “2” indicating that the corresponding index paper is the second index paper among “B”. That is, each of the character strings “A” and “B” is handled as identification information for uniquely identifying a group of index paper.

Even if, therefore, two or more types of index paper are set in a book file, it is possible to easily recognize the page as a page corresponding to index paper and to recognize at a glance the type group of index paper and the ordinal number of the index paper in the group.

Although this embodiment has been described by using two types of index paper, that is, 5-tab index paper and 7-tab index paper, the embodiment may be configured to use, for example, two 5-tab index page groups and display them so as to allow to identify them.

In addition, this embodiment has exemplified special insertion sheets as index paper in comparison with plain paper, thick paper, coated paper, and the like, the type of special insertion sheets is not limited to this. The present invention can be applied to paper sheets of other forms.

As has been described above, according to each embodiment described above, it is possible to easily make print settings, when outputting printed product by using an image forming apparatus, with combinations of generally used paper sheets such as plain paper, thick paper, and coated paper and special insertion sheets such as index paper with index tabs. Although the present invention has been described by using index paper, index paper may be replaced by, for example, ordered colored paper sheets.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-024524, filed Feb. 7, 2012, which is hereby incorporated by reference herein in its entirety.

What is claimed is:

1. An information processing apparatus which prints a printed product including a plurality of pages, the apparatus comprising:
an accepting unit configured to accept one of a setting for designating, by a feed unit, a paper sheet to be inserted at a desired position of the plurality of pages, and a setting of designating, from a type of paper, a paper sheet to be inserted at a desired position of the plurality of pages; and
a display control unit configured
to display, when the setting for designating the paper sheet by a feed unit is made and a type of paper fed from the feed unit designated by the user is a predetermined type of paper, a screen for setting detail information of the predetermined type of paper, and
to display, when the setting for designating the paper sheet by a paper type is made and a type of paper designated by the user is a predetermined type of paper, a screen for setting a feed unit which feeds the designated predetermined type of paper and detail information of the designated predetermined type of paper.

2. The apparatus according to claim 1, further comprising a setting unit configured to accept a setting for printing a specific one of the plurality of types of paper for each of the plurality of pages.

3. The apparatus according to claim 1, further comprising a table which holds detail information of the predetermined type of paper fed from each of the plurality feed units of a printing apparatus in association with the plurality of feed units.

4. The apparatus according to claim 3, wherein said display control unit acquires, when a setting for designating the paper sheet by a feed unit is made and a feed unit which feeds the predetermined type of paper is designated, detail information of a predetermined paper sheet which is configured to be fed by the designated feed unit from said table, and displays the screen as an initial setting, and
acquires, when a setting for designating the paper sheet by a paper type is made and the predetermined type of paper is designated, a feed unit which is configured to feed the predetermined type of paper and detail information of the predetermined type of paper from said table, and displays initial settings on the screen.

5. The apparatus according to claim 1, further comprising a changing unit configured to acquire, when a setting is made to feed different types of paper from the same feed unit with respect to a type of paper set for each of the plurality of pages, information of a type of paper which the feed unit is configured to feed, and to change the type of paper set for each of the plurality of pages in accordance with the acquired information of the type of paper.

6. The apparatus according to claim 1, wherein the predetermined type of paper is index paper having an index tab.

7. An information processing method in an information processing apparatus which prints a printed product including a plurality of pages, the method comprising:
accepting one of a setting for designating, by a feed unit, a paper sheet to be inserted at a desired position of the plurality of pages, and a setting of designating, from a type of paper, a paper sheet to be inserted at a desired position of the plurality of pages;
displaying, when the setting for designating the paper sheet by a feed unit is made and a type of paper fed from the feed unit designated by the user is a predetermined type of paper, a screen for setting detail information of the predetermined type of paper, and
displaying, when the setting for designating the paper sheet by a paper type is made and a type of paper fed designated by the user is a predetermined type of paper, a screen for setting a feed unit which feeds the designated predetermined type of paper and detail information of the designated predetermined type of paper.

8. The method according to claim 7, further comprising accepting a setting for printing a specific one of the plurality of types of paper for each of the plurality of pages.

9. The method according to claim 7, further comprising a table which holds detail information of the predetermined type of paper fed from each of the plurality feed units of a printing apparatus in association with the plurality of feed units.

10. The method according to claim 9, wherein, when a setting for designating the paper sheet by a feed unit is made and a feed unit which feeds the predetermined type of paper is designated, detail information of a predetermined paper sheet which is configured to be fed by the designated feed unit is acquired from the table, and the screen is displayed as an initial setting, and
when a setting for designating the paper sheet by a paper type is made and the predetermined type of paper is designated, a feed unit which is configured to feed the predetermined type of paper and detail information of the predetermined type of paper are acquired from the table, and the information is displayed as initial settings on the screen.

11. The method according to claim 7, further comprising acquiring, when a setting is made to feed different types of paper from the same feed unit with respect to a type of paper set for each of the plurality of pages, information of a type of paper which the feed unit is configured to feed, and changing the type of paper set for each of the plurality of pages in accordance with the acquired information of the type of paper.

12. The method according to claim 7, wherein the predetermined type of paper is index paper having an index tab.

13. A non-transitory computer-readable medium storing a program for causing a computer to function as
an accepting unit configured to accept one of a setting for designating, by a feed unit, a paper sheet to be inserted at a desired position of a plurality of pages constituting printed product, and a setting of designating, from a type of paper, a paper sheet to be inserted at a desired position of the plurality of pages; and
a display control unit configured to
display, when the setting for designating the paper sheet by a feed unit is made and a type of paper fed from the feed unit designated by the user is a predetermined type of paper, a screen for setting detail information of the predetermined type of paper, and
to display, when the setting for designating the paper sheet by a paper type is made and a type of paper designated by the user is a predetermined type of paper, a screen for setting a feed unit which feeds the designated predetermined type of paper and detail information of the designated predetermined type of paper.

14. The medium according to claim 13, wherein the program further causes the computer to function as a setting unit configured to accept a setting for printing a specific one of the plurality of types of paper for each of the plurality of pages.

15. The medium according to claim 13, further comprising a table which holds detail information of the predetermined type of paper fed from each of the plurality feed units of a printing apparatus in association with the plurality of feed units.

16. The medium according to claim 15, wherein the display control unit acquires, when a setting for designating the paper sheet by a feed unit is made and a feed unit which feeds the predetermined type of paper is designated, detail information of a predetermined paper sheet which is configured to be fed by the designated feed unit from the table, and displays the screen as an initial setting, and
acquires, when a setting for designating the paper sheet by a paper type is made and the predetermined type of paper is designated, a feed unit which is configured to feed the predetermined type of paper and detail information of the predetermined type of paper from the table, and displays the information as initial settings on the screen.

17. The medium according to claim 13, wherein the program further causes the computer to function as a changing unit configured to acquire, when a setting is made to feed different types of paper from the same feed unit with respect to a type of paper set for each of the plurality of pages, information of a type of paper which the feed unit is configured to feed, and to change the type of paper set for each of the plurality of pages in accordance with the acquired information of the type of paper.

18. The medium according to claim 13, wherein the predetermined type of paper is index paper having an index tab.
